(19) United States
(12) Patent Application Publication
(10) Pub. No.: US 2015/0186605 A1
(43) Pub. Date: Jul. 2, 2015

(54) RESEARCH AND DISCOVERY UNIT

(71) Applicant: Indiana University Research and Technology Corp., Indianapolis, IN (US)

(72) Inventor: Malaz Boustani, Carmel, IN (US)

(21) Appl. No.: 14/587,566

(22) Filed: Dec. 31, 2014

Related U.S. Application Data
(60) Provisional application No. 61/922,518, filed on Dec. 31, 2013.

(51) Int. Cl. G06F 19/00; G06F 3/0484; G06F 3/0481

(52) U.S. Cl. CPC G06F 19/327; G06F 3/04817; G06F 3/04842

(57) ABSTRACT

The present disclosure provides a system that records, analyzes, and transforms data to streamline procedures and reduce variations in outcomes. Also disclosed is a method for recording, analyzing, and presenting data with a triple aim of producing better medical care, better health outcomes, and lower cost in health care settings.

### PRIORITY CLAIM

This application claims priority to U.S. Provisional Patent Application Ser. No. 61/922,518, filed Dec. 31, 2013, the complete disclosure of which is hereby incorporated herein by reference in its entirety.

### FIELD

The present disclosure relates generally to a system that records, analyzes, and transforms data to streamline procedures; implements evidence-based practices; and reduces variations in clinical outcomes. More particularly, the present disclosure relates to a method for recording, analyzing, transforming, and presenting data by a user interface displayed on a computer with a triple aim of producing better medical care, better health outcomes, and lower costs in health care settings.

### BACKGROUND

The exponential growth of health care spending in the US has caused consumers, insurers and policy makers to question the value of care that is being delivered for every dollar spent on health. The increasing need to clearly exemplify the value of US health care systems has led to extreme scrutiny and examination of our health systems' structures, processes, and outcomes. In order to deliver better value, responsible delivery systems are participating in accountable care initiatives and population health management by moving their business model from a fee-for-service payment structure, where volume is the driver, to one of value-based purchasing and population health.

This new delivery model based, on accountable care initiatives and population health management, requires current health systems to transform into learning health care systems. Learning systems are capable of adapting to the constantly changing healthcare delivery environment, and have a knowledge bank, or memory system, as well as an objective data system that acts as a timely feedback loop to help guide the transformation. Learning systems also achieve and accomplish competitive and individualized value for patients, while accomplishing the triple aim of better care and better health at a lower cost.

A transformation of health care delivery requires the creation of a knowledge management engine within the new learning health care system. This knowledge management system must be capable of discovering innovative health care delivery solutions, adopting evidence-based medicine, and utilizing implementation science to rapidly disseminate effective solutions across the enterprise, as well as quickly eliminate failed or ineffective solutions. In health care delivery systems, inappropriate variation is a potential source of waste, patient harm, and increased costs in care.

Implementation science is a multidisciplinary approach to effect change and promote systematic uptake of evidenced-based practices or programs into routine practices. By utilizing implementation science tools, health care providers become more aware of any unintended consequences that may transpire as a result of the clinical decisions made.

Thus, there is a need for a system that records and analyzes data to streamline procedures and reduce variations in outcomes in health care delivery. More particularly, there is a need for a method for recording, analyzing, transforming, and presenting data on a user interface displayed on a computer with the triple aim of producing better medical care, better health outcomes, and lower cost in health care settings. Discussed herein is an implementation science framework that proposes the presence of three distinct sources of both appropriate and inappropriate variations that respond to different quality improvement strategies, tactics and techniques.

### SUMMARY

The present disclosure is directed toward a Research and Discovery Unit (“RDU”) which uses implementation science to transform health care delivery systems into learning health care systems. The RDU uses a computer or similar electronic system to record, store, process, statistically analyze, and graphically present data to health care providers in a manner that allows rapid or real-time improvement in care, reduction in unwanted variations or inefficiencies, and reduction in cost. The RDU comprises an interactive personnel team with its ideas, methods, and solutions being implemented and evaluated via software.

The RDU can optionally operate within finance, operations, and/or quality departments. The RDU likely will be operated within the medical quality departments of health care providers, and exists to provide system level support for quality improvement activities within the informed clinical decision domain. The informed clinical decision domain represents the variation that exists when a clinician makes a decision on the type of care that will be provided to the patient. The RDU will ignite innovation and implementation science by bringing evidence-based solutions for a given improvement effort, and/or knowledge management, to implement, disseminate, and scale up the proven improvement.

One goal of the RDU is to enhance, as well as advance traditional quality improvement methodologies by adding a research arm to existing quality departments. This is significant because health care systems across the nation are looking for ways to produce cost savings and increase overall quality of care. With shifts in reimbursements, this skill set and methodology has become increasingly important and vital for future success.

The RDU of the present disclosure, implemented with a unique user interface displayed on a computer, provides a significant improvement over prior systems and methods. Improvements to the healthcare field, specifically the accessible technology in the field, are needed to improve outcomes for both patients and care givers.

In one embodiment, to ensure that the implementing health care system receives the best return on investment (“ROI”) for its quality improvement activities, the RDU engages in a rigorous triage process with the system's chief innovation and implementation officers to prioritize opportunities based on the following: (1) the presence of a large opportunity to make a significant system impact in quality, cost savings, or new revenue generation (a large opportunity in one embodiment is a potential impact of at least $5 million per year); (2) the lack of evidence in the way care is currently being delivered, which drives the need for implementation of existing evidence-based knowledge to improve the quality of care, as well as the overall cost of care; (3) the opportunity is system-wide in scope or easily replicable in multiple units or entities or across service lines; (4) the opportunity is in alignment with the implementing health care provider's strategic aims; and (5) the breadth of impact.

In another embodiment, the RDU team is an internal consulting team, which will seek expertise from the chief innovation and implementation officers as needed to ignite innovation and implementation science by: (1) eliminating ineffective solutions; (2) identifying evidenced-based solutions for a given improvement effort; (3) localizing and implementing the evidenced based solution(s) identified; (4) disseminating and scaling up proven improvements; and (5) commercializing proven innovative health care solutions.

The RDU optionally will identify knowledge opportunities by using a software dashboard as its “GPS” to flag issues that potentially will cause significant, harmful losses (financial, reputation, and/or service) to the health care provider. A knowledge opportunity, rather than a process opportunity, means there is an opportunity for implementation of evidenced-based practices or knowledge to reduce unnecessary variation that exists before a clinician prescribes an order to the patient. On the other hand, a process opportunity exists after an order has already been prescribed.

The RDU includes a process for engagement. The process for engagement includes a letter of inquiry or similar request to the RDU by a requester, a diagnosis by the RDU, and an initial consultation. The process begins once a letter of inquiry or similar inquiry is made to the RDU team. Such inquiries or requests may be made by a requester, that includes, but is not limited to, hospitals, service lines, and physician leaders; or it may be initiated at the request of a health care provider's executive leadership, based on strategic mandates, or simply initiated directly by the RDU after approval by a health care provider's executives. By providing a brief description of the improvement need, this allows RDU staff to begin a comprehensive discovery phase.

The purpose of a letter of inquiry or similar request is to assist the RDU in the problem and opportunity identification process, as well as provide a tool for intelligent and precise allocation of RDU resources to benefit the health care provider's overall system goals. At this stage of the process, in one embodiment, the RDU team will be able to quickly redirect any requests that do not meet the minimum criteria for RDU engagement to the most appropriate quality improvement team. An assigned RDU contact works with the customer to define desired outcomes or a desired future state. By using current data, knowledge banks, queries, knowledge management and drawing on the health care provider's local expertise, the final process designed has the ability to redefine the opportunity for improvement and prevent failed solutions with interventions at the onset (failure reduction). This process also allows the RDU to identify process variations that may be more effectively dealt with by process improvement teams, using Lean and Six Sigma methodology, which can then make appropriate referrals.

Following the letter of inquiry or similar request, the RDU team will provide a diagnosis or critical assessment of the customer's scope of work, and as a result of the critical assessment and preliminary evaluation, the RDU team will develop initial findings, which will be documented in a memorandum of understanding (“MOU”) or similar document. The critical assessment provides a critical review of the information provided in the letter of inquiry or similar inquiry.

In one embodiment, after the critical assessment, the RDU team will schedule an initial face-to-face meeting or initial consultation with the customer's leadership team to present the preliminary findings for review and discussion. Revisions to and finalization of the MOU will outline the parameters for ongoing work between the RDU and the customer.

Following a process for engagement, additional RDU services are provided. In one embodiment, the RDU provides identification of large opportunities for improvement within a health care provider system using: (1) a software dashboard as a system-level annual performance tool; (2) continuous scanning of national health care initiatives; (3) annual systematic review of the published literature for innovative health care solutions; (4) annual strategic meetings with RDU chief innovation and implementation officers; and (5) physician feedback via periodic, possibly monthly, innovation forums.

In another embodiment, the RDU provides a critical review of areas such as service lines, hospitals, health plans or other areas where an opportunity for improvement might exist. The critical review of areas in one embodiment includes critical assessment, critical feedback, and critical advice. The customer, health care provider, or other RDU implementer, can expect recommendations for specific metrics that will determine success or failure as a part of the evaluation plan, as well as a timeline for implementation. During the period of implementation and periodic metric review, the RDU will provide the content experts and implementers with a function that has been likened to a GPS. The ability to provide an early warning when interventions are heading off course and provide for course correction will save valuable time. The GPS function will predict and measure the impact of the predetermined desired outcomes or clinical improvements.

In still another embodiment, the RDU provides identification of the problem and transforms the problem into an operational question(s). In another embodiment, the RDU provides identification of the current state of a gap or a deficiency in a health care provider system or operation and works with decision support or a data warehouse team to verify that a problem actually exists.

In one embodiment, the RDU provides identification of who (personnel) and what (methodology or equipment) is needed to fill the current state of a gap or deficiency in a health care provider system or operation. In one embodiment, this identification includes the steps of: (1) guiding team identification processes by ensuring that individuals selected will compose teams that are multidisciplinary and diverse; (2) identifying and engaging executive champions and physician champions; (3) identifying a project manager; (4) setting the minimum specified criteria for team meetings, interactions, and communications; and (5) setting the team's constraints (e.g. budget, amount of resources) up front to focus the team on the concept of “Innovating in Africa” (innovating with a limited budget) when identifying and selecting a solution.

In still another embodiment, the RDU provides identification of a future state or a desired state for the health care provider by working with project team members to clearly and objectively develop metrics that define what success looks like and working with decision support to identify and gather the data needed to populate those metrics.

In one embodiment, the RDU provides identification of evidence-based solutions to solve the problem. The RDU might check internal and external knowledge banks to determine if others have tried to solve this problem before and learn from past failures or successes to accelerate solution identification process. Additionally, the RDU may check academic and medical literature to determine if an evidence-based solution exists that delivers the triple aim. If a solution does not exist, the RDU may organize an innovation forum to innovate and invent a new solution. Innovation forums allow time and space for physicians to be engaged with implementation science-related activities, and provide a meeting space for physicians to discuss current issues, as well as give them the opportunity to provide solutions to the issues presented.

In a further embodiment, the RDU develops an implementation plan. The implementation plan will consist of strategies, resources, and/or skill sets needed to successfully implement the interventions identified for improvement. Tools available to the team will include: systematic searches of published effective solutions and national guidelines; standard process improvement tools such as process mapping and flow charting; aids to the process such as timelines or Gantt charts; and the innovation forum to engage physicians in the implementation process. The implementation plan may be subject to iterative cycles, depending on measurement and evaluation, but ultimately goals will be met, at which point the goals outlined in the MOU will be completed.

In another embodiment, the RDU creates a communications plan, which optionally may comprise any combination of the following elements: (1) recommended tactics for communicating and soliciting feedback and educating physicians and staff; (2) information about the target audience; (3) the goals; (4) information the audience needs to buy-in to and how this will be measured; (5) meaningful actions that need to be taken; (6) strategy; (7) key messages to primary and secondary audiences; (8) a particular communication tone; (9) particular communication channels; (10) reinforcing materials (e.g. letters, pocket cards, posters); (11) interactive communication tactics (e.g. lunch and learns); and/or (12) reinforcing communication tactics (e.g. townhalls).

In still another embodiment, the RDU provides localization of the identified evidence-based solution. Optionally, this may comprise (1) setting the minimum specified criteria for the care delivery model; (2) identifying if other resources are needed to implement the solution; and (3) engaging in multiple rapid cycle experimentations to update the solution identified and ensure that it meets the needs of the local environment to deliver the triple aim.

The RDU, in another embodiment, provides creation of an evaluation plan, wherein the evaluation plan optionally comprises: (1) pre-launch analytics and a GPS tracking system, wherein there is the ability to provide content experts and implementers an early signal(s) for failure reduction and to detect when the solution or intervention is heading in the wrong direction by using current data, knowledge banks, queries and focus groups to make the necessary course corrections; (2) a protocol and/or analytic plan to monitor if the solution is producing the triple aim; and (3) a plan that specifically defines the metrics that will be used to determine failure, success, and the evaluation process, as well as an appropriate timeframe to decide whether or not the solution or intervention worked.

Over time, the RDU will optionally create a knowledge bank of solutions that have been implemented at the health care provider or across multiple health care providers to solve various problems. The knowledge bank will allow users to quickly discover if a solution was a failure or success. The knowledge bank will act as a health care provider's memory in its transformative journey in becoming a learning health care system, and it will accelerate the problem and solution identification process for health care providers.

The RDU will optionally work with the health care provider's executives and implementers to create real-time data feedback loops that are capable of producing actionable, objective information that will help implementers and physicians modify their interventions and practices accordingly to deliver the best value for their patients and meet the needs of both population health management and personalized medicine.

The RDU optionally will be evaluated by the implementer(s) according to three categories. Category 1 optionally includes (1) health system or programmatic outcomes and (2) increased physician engagement and communication. Health system or programmatic outcomes optionally include: (1) overall cost savings or revenue generated by the projects facilitated by the RDU; (2) overall improvement in value-based purchasing (“VBP”) and other quality measures targeted by the projects facilitated by the RDU; and (3) overall increase in grant amounts facilitated by the RDU team. Increased physician engagement and communication measures optionally include: (1) number of physician champions; (2) number of physicians in attendance at innovation forums; and (3) number of physicians involved in quality improvement, implementation science and process improvement activities.

Category 2 optionally includes customer perspective or customer satisfaction and is evaluated by customer feedback on RDU helpfulness in improvement processes wherein customer feedback is gathered from a customer feedback form. Category 3 optionally includes RDU operational or process metrics including those such as, but not limited to: (1) the number of contracts or requests for RDU service; (2) the ability to hit targets and outcomes set for each customer; (3) referrals from previous customers; and (4) the number of grants, consulting agreements, publications, national presentations and patents for innovation secured or attributable to the RDU.

RDU personnel in one embodiment comprises: (1) leadership; (2) team members; (3) team support; and (4) administrative support. Leadership positions optionally include a vice president of system quality for oversight of strategic activities and ensuring alignment with system goals; an implementation scientist for oversight of programmatic function and links with implementers; and an executive director for oversight of operational function who also works as a part of the RDU team and is responsible for assigned teams.

Team members optionally comprise one or more project coordinators for vetting initial requests, planning and evaluating project activities from initiation to implementation, assembling appropriate teams for each customer, and being the contact person for assigned teams; biostatisticians for working to develop evaluation plans for each project; consultants; and data analysts for working in collaboration with IT and decision support and providing needed data and critical analysis.

Team support optionally includes an academic detailer and an IT analyst. The academic detailer provides for interfacing with customers or potential customers to highlight benefits of the RDU (similar to a drug representative's function), helping manage the message, assisting with new business recruitment and spreading to regional hubs, and working with physician innovation forums. The IT analyst provides for assisting with all IT issues, managing websites, and working with the software dashboard team.

Administrative support optionally includes an administrative assistant for answering phones, meeting management, maintaining minutes, tracking initial inquiries and all phases of maintaining project records and timeliness. Administrative support may also provide advanced computer expertise with charts and programs such as Microsoft Word, Publisher, Visio, etc.

Additional consultant expertise in the RDU optionally may include: (1) implementation scientists with the ability to translate health services, effectiveness, outcomes and comparative research into clinical practice; (2) industrial engineers with the ability to integrate people, technology, and information to enhance operational processes; (3) senior biostatisticians with the ability to carry out research, devise experiments, and provide in-depth analysis of all results; and (4) health economists with the ability to evaluate efficiency, effectiveness, value and behaviour in the production and consumption of health and health care.

Innovation forums optionally use a model developed by the Hartford Foundation referred to as “Consultancy.” A Consultancy is a grouping of problem-solving activity that is structured to enable a set of people with a variety of knowledge and expertise to provide support, new perspectives, and ideas to one another, particularly around an important or difficult challenge.

Either during the assessment phase or at the completion of the project, the RDU may identify processes or outcomes that represent a leading practice and are worthy of replication for significant system impact. The RDU offers detection, verification, and replication of positive outliers or deviance. It also offers detection and verification of negative outliers or deviance in order to reduce harmful variations. The RDU can implement identified best practices in one of several ways.

In one embodiment, protocolization of processes to standardize the improvements is used. In this embodiment, industrial engineer workflow processes and time motion analyses could be used. Or, protocolization could be achieved through adoption of system protocols, for example a multi-entity pharmacy and therapeutics committee for pharmacy protocols. Protocolization could also be achieved through order sets or order plans standardized in the emergency room, or through the development of a replication manual or operations procedure manual.

In another embodiment, dissemination of leading practices is achieved through existing and in-development quality portals. In this embodiment, dissemination is achieved through the development of a messaging plan for each evidence-based practice or leading practice. Alternatively, dissemination could be achieved through the use of the physician engagement platform of the innovation forum or the Consultancy model. Or, dissemination could be achieved through the use of academic detailers as the messengers of the targeted leading practice.

In yet another embodiment, scalability is used to implement identified best practices by spreading leading practices and tools to other units or entities. This can be accomplished by working closely with service line leaders to assure accountability, which will result in successful spread of the improvement(s) and engagement of physician partners through care groups. Ultimately, developing and engaging regional RDUs accelerates the implementation process.

Finally, in another embodiment, commercialization of the innovative health care solution would help cement it as a best or leading practice. In summary, the RDU concept offers the consumer, customer, health care provider, and/or implementer the opportunity to work with the RDU team from the initial conceptualization of the improvement opportunity (a “package”) or to engage the RDU team for only select steps or tools (specific “products”).

Referring specifically to the above-mentioned software dashboard, in some embodiments a user interface is displayed on a computer. This is one element that allows the RDU to provide identification of large opportunities for improvement within a health care provider system. The software dashboard is a software application with the ability to record, store, arrange, statistically analyze, transform, and graphically display data in real-time. In one embodiment, the software dashboard is a spreadsheet workbook, such as Excel or a similar commercial spreadsheet program, comprising a main dashboard worksheet with the metrics and graphics for the metrics. The spreadsheet workbook also optionally contains worksheets for data and control charts, or these could be contained in a separate but linked spreadsheet workbook or similar software program.

In one embodiment, the software dashboard has macros, such as Visual Basic Macros, for navigation among the worksheets and for creating the dashboard graphics. The workbook is a template that can take data for the metrics of all cores combined, and it has the flexibility to be copied, renamed, and to have the data for the metrics by individual cores, rooms, surgeons and other categories pasted into it, if it is possible to extract the data sets in this way. To have a core 1 dashboard, a user can copy the workbook, rename it, and insert the metric data for core 1 only.

The data used for computing the metrics and creating the control charts are input through data worksheets. The computation and logic used for the metrics and graphics is done on the control chart worksheets which also contain control charts which are timeplots of the data. Tabs for the worksheets are optionally color coded as follows: (1) main dashboard as a first color, for example, gray, (2) data worksheets as second color, for example, cream, and (3) control chart worksheets as a third color, for example, crimson. Other colors could be substituted.

Table 1 below lists the data worksheets and control chart worksheets associated with each metric as well as the control chart types. In one embodiment, data sheets contain daily data for the last year, monthly data for the last year, and daily data for the last month. Data for which the dates of daily data for the last year are the same are grouped onto the same data sheets. Control chart worksheets optionally display a time plot with colored points to indicate nonrandom phenomena. Control chart worksheets also optionally contain logic for determining non-randomness and trends.

TABLE 1
One embodiment of quality metrics to be displayed with a user interface displayed on a computer.

| Metric | Data Worksheets | Control Chart Workheets | Chart |
|---|---|---|---|
| Number of cancellations within 24 hours of surgery | DailyDataYear | Cancel24hrMonthCC | c-chart |
| | DailyDataMonth | Cancel24hrYearCC | |
| | MonthlyDataYear | | |
| % of cancellations within 24 hours of surgery | DailyDataYear | %Cancel24hrMonthCC | p-chart |
| | DailyDataMonth | %Cancel24hrYearCC | |
| | MonthlyDataYear | | |
| Flash sterilization rate | FlashData | FlashRateYearCC | p-chart |
| Flash sterilization rate - implants | FlashData | ImplantFlashRateYearCC | p-chart |
| Safety attitude questionnaire - OR version | No data | No control chart | |
| Same Day Surgery - % of patients readied at least 30 | SDSDailyDataYear | SDS%MonthCC | p-chart |
| minutes prior to scheduled start | SDSDataMonth | SDS%YearCC | |
| | SDSMonthlyDataYear | | |
| Same Day Surgery - number of patients readied at | SDSDailyDataYear | SDSNum>30MonthCC | c-chart |
| least 30 minutes prior to scheduled start | SDSDataMonth | SDS>30YearCC | |
| | SDSMonthlyDataYear | | |
| OR - % of first cases started on time | 1stCaseDailyDataYear | 1stCaseMonthCC | p-chart |
| | 1stCaseDailyDataMonth | 1stCaseYearCC | |
| | 1stCaseMonthlyDataYear | | |
| OR - Subsequent case start times | SubCaseDailyDataYear | SubCaseMonthCC | p-chart |
| | SubCaseDailyDataMonth | SubCaseYearCC | |
| | SubCaseMonthlyDataYear | | |
| OR - AverageTurnover time in minutes - previous | DailyDataYear | TOTX-barMonthCC | x̅-chart, |
| patient out to next patient in | DailyDataMonth | TOTSMonthCC | s-chart |
| | MonthlyDataYear | TOTX-barYearCC | |
| | | TOTSYearCC | |
| OR - % of cases that are turned over in 30 minutes | DailyDataYear | %<30TOTMonthCC | p-chart |
| or less. | DailyDataMonth | %<30TOTYearCC | |
| | MonthlyDataYear | | |
| OR - Average Turnaround time in minutes - previous | DailyDataYear | TATX-barMonthCC | x̅-chart, |
| surgery stop to next surgery start | DailyDataMonth | TATSMonthCC | s-chart |
| | MonthlyDataYear | TATX-barYearCC | |
| | | TATSYearCC | |
| OR - Number of delays from patient in room to | DailyDataYear | AnStDlyMonth | c-chart |
| anesthesia start | DailyDataMonth | AnStDlyYear | |
| | MonthlyDataYear | | |
| OR - Average time in minutes from anesthesia start | DailyDataYear | AnSurgSttX-barMonthCC | x̅-chart, |
| to surgery start | DailyDataMonth | AnSurgStSMonthCC | s-chart |
| | MonthlyDataYear | AnSurgStX-barYearCC | |
| | | AnSurgStSYearCC | |
| OR - Average time in minutes from surgery stop to | DailyDataYear | SurgStpPORX-barMonthCC | x̅-chart, |
| patient out of room | DailyDataMonth | SurgStpPORSMonthCC | s-chart |
| | MonthlyDataYear | SurgStpPORX-barYearCC | |
| | | SurgStpPORSYearCC | |
| OR - Average actual minus scheduled case duration | DailyDataYear | SchActX-barMonthCC | x̅-chart, |
| in minutes | DailyDataMonth | SchActSMonthCC | s-chart |
| | MonthlyDataYear | SchActX-barYearCC | |
| | | SchActSYearCC | |
| PACU - Number of admission delays | DailyDataYear | PACUNumAdmDlyMonthCC | c-chart |
| | DailyDataMonth | PACUNumAdmDlyYearCC | |
| | MonthlyDataYear | | |
| PACU - Average length of stay in minutes | DailyDataYear | PACUlenstayX-barMonthCC | x̅-chart, |
| | DailyDataMonth | PACUlenstaySMonthCC | s-chart |
| | MonthlyDataYear | PACUlenstayX-barYearCC | |
| | | PACUlenstaySYearCC | |
| PACU - Number of stays > 120 | DailyDataYear | PACUNumlensty>120MonthCC | c-chart |
| | DailyDataMonth | PACUNumlenstay>120YearCC | |
| | MonthlyDataYear | | |
| PACU - % of stays > 120 minutes | DailyDataYear | PACU%>120MonthCC | p-chart |
| | DailyDataMonth | PACU%>120YearCC | |
| | MonthlyDataYear | | |
| Patient satisfaction | No data | No control chart | |

Another possible set of hospital outcomes for the software dashboard to monitor comprises: average hospital length of stay; length of stay for each hospitalization within 90 days after an index hospitalization; rate of 30-day, 60-day, and 90-day readmissions including (i) time to first readmission within six months of hospitalization and (ii) time to death within six months of hospitalization; rate of preventable admissions (use ambulatory sensitive measures); rate of preventable Emergency Department (ED) visits (use ambulatory sensitive measures); rate of returns to ED following first ED visit at 72 hours or at seven days; number of never events; rate of hospital acquired complications (using CMS definitions); the average (or median) total cost of admission; the average (or median) total reimbursement for admission; the average (or median) cost of physician order for laboratory tests per admission; the average (or median) cost of physician order for imaging tests per admission; the average (or median) cost of physician order for all medications per admission; the average (or median) cost of physician order for all generic medications per admission; CMS-related total value-based purchasing loss (over the next 12 months); Anthem-related total pay-for-performance loss (over the next 12 months); rate of all staff turnover over the past month, 3 months, 6 months or 12 months; rate of all physician turnover over the past month, 3 months, 6 months, or 12 months; rate of all nurse turnover over the past month, 3 months, 6 months or 12 months; rate of all case manager turnover over the past month, 3 months, 6 months or 12 months; average satisfaction score over the past month, 3 months, 6 months or 12 months for (i) patients, (ii) physicians, and (iii) employees.

In another embodiment of the software dashboard, a control chart is a time plot of data from a process with the purpose of discerning whether the process is stable, with variation only coming from sources common to the process, or not stable with variation coming from identifiable causes. This is based on the assumption that identifiable causes of variation produce statistically significant patterns of variation and that sources common to the process do not produce statistically significant patterns of variation. In other words, a control chart is used to identify patterns of variation that are statistically significant so that the user does not react to variation that is not statistically significant.

In one embodiment, the dashboard uses four types of control charts depending on the type of data: x̅-charts plotting means and s-charts plotting standard deviation for continuous data such as turnover time; p-charts plotting proportions such as flash rate; and c-charts plotting count data such as number of cancellations.

In situations where an x̅-chart enables a user to see how the center of a process changes over time, a second chart is necessary to enable the user to see how the spread or consistency of the data is changing over time. If the sample sizes are greater than 10, an s-chart is used. In the case of proportions (p-charts) and count data (c-charts), the spread is related to the proportions and counts being plotted so an additional chart to display the spread is unnecessary.

An x̅-chart is a time plot of means of samples from a process with lines for the mean of the process data and lines for the upper and lower control limits which are lines set two or three standard deviations above and below the line for the mean. The standard deviations are for the distribution of sample means, not the standard deviation of the process. If the sample size is constant, the standard deviation of the distribution of sample means is the standard deviation of the process divided by the square root of the sample size. For the metrics of this dashboard, the sample sizes are variable so the standard deviation of the distribution of sample means is computed directly from the sample means.

Normally distributed data has about 95.45% of the values within two standard deviations of the mean and about 99.73% of the values within three standard deviations of the mean. If the sample sizes are large, the distribution of sample means is normal. Data for a software dashboard likely will meet the criteria for a normal distribution where the number of surgeries or procedures is large (over 1000 per month). This means that the probability that a data point plotted on an x̅-chart would fall outside two standard deviations is less than 5% and the probability that a data point would fall outside three standard deviations is less than 1%. A probability of 5% or less is considered to be statistically significant under most circumstances.

A p-chart is a time plot of sample proportions. The distribution of sample proportions is approximately normal with a mean equal to population proportion mean p and a standard deviation of

$$\sqrt{\frac{p ( 1 - p )}{n}}$$

where n is the sample size. The sample sizes vary for the samples in the p-charts of the dashboard so the average sample size over the time horizon plotted is used for n. Like the x̅-chart, the p-chart has lines for the overall proportion of the process data and lines for the upper and lower control limits which are lines set two or three standard deviations above and below the line for the proportion calculated over long term historic data. The standard deviations are calculated using the formula

$$\sqrt{\frac{p ( 1 - p )}{n}}$$

where n is the average sample size and p is the proportion over the last year. Because this is an approximately normal distribution, the probability that a data point plotted on a p-chart would fall outside two standard deviations is less than 5% and the probability that a data point would fall outside three standard deviations is less than 1%.

The count data for the c-chart comes from a Poisson distribution with a mean c and a standard deviation of \sqrt{c}. Like the x̅-chart and the p-chart, the c-chart has lines for the overall proportion of the process data and lines for the upper and lower control limits which are lines set two or three standard deviations above and below the line for the proportion calculated over long term historic data. For c>20, the Poisson distribution can be approximated by a normal distribution. For most of the c-charts on the software dashboard, this applies so the probabilities for being outside one or two standard deviations is similar to those for the x̅-charts and the p-charts and for c<21, direct calculation shows that the probabilities are much smaller.

A process is considered stable if there are no statistically significant variations. The following rules, which are a combination of the Western Electric and Nelson signal processing rules, are statistically significant conditions having probabilities less than 5%. If any of the conditions in Table 2 are met, the process is not stable.

TABLE 2
Exemplary logic rules for determining statistically significant
deviations from normally distributed data.

1 point outside of control limits (usually 2 or 3 standard deviations)
1 point outside 3 standard deviations
2 of 3 consecutive points outside 2 standard deviations
4 of 5 consecutive points out1standard deviation
5 or more points consecutive points trending upward
5 or more points consecutive points trending downward
14 or more points alternating up and down
15 consecutive points within 1standard deviation
8 or more consecutive points above mean
8 or more consecutive points below mean

If a process is stable and achieving target performance, then no corrections or changes to the process are needed or desired. Moreover, changing a stable process that is meeting target performance can lead to instability and poor performance. Another benefit of process stability is that data from the process can be used to predict the future performance of the process.

If the software dashboard indicates that the monitored process is not stable—which means that identifiable causes of variation are present, analysis of the control chart can help determine the sources of variation. The identification of these causes can be used to improve the process. A process that is stable but not achieving target performance needs to be improved through a deliberate effort to understand the causes of current performance and fundamentally improve the process.

Signal processing rules determine statistically significant variations but not all statistically significant variations are trends. To find trends in the data, the signal processing rules are modified to find statistically significant variations that are also trends in the most recent data. In one embodiment, the rules to determine a trend for a goal to go below a target value are as follows in Table 3.

TABLE 3
Exemplary rules to determine a positive (advantageous)
trend for a goal to go below a target value.

| Improve | Decline |
|---|---|
| Last point 3 standard deviations | Last point 3 standard deviations |
| below mean or lower | above mean or higher |
| Last 2 out of 3 points 2 standard | Last 2 out of 3 points 2 standard |
| deviations below mean or lower | deviations above mean or higher |
| Last 4 out of 5 points 1 standard | Last 4 out of 5 points 1 standard |
| deviation below mean or lower | deviation above mean or higher |
| Last 6 points below mean | Last 6 points above mean |
| Last 6 points going down | Last 6 points going up |
| Last 3 points going down with last | Last 3 points going up with last |
| point 2 standard deviations below | point 2 standard deviations above |
| mean or lower | mean or higher |
| Last 4 points going down with last | Last 4 points going up with last |
| point 1 standard deviations below | point 1 standard deviations above |
| mean or lower | mean or higher |
| Last 5 points going down with last | Last 5 points going up with last |
| point below mean or lower | point above mean or higher |

The rules for the goal to go above a target value are analogous. The trend rules are applied to the control charts with a year-long time horizon with monthly time buckets.

In another embodiment, the spreadsheet workbook containing the software dashboard has three types of macros, possibly designed in Visual Basic, or a similar program, including the following: (1) navigation among worksheets, (2) graphics, and (3) conditional formatting. Macros can be accessed through the Code section of the Developer tab in Excel, or by similar methods in other spreadsheet software programs.

The macros for navigating among worksheets optionally begin with the letters goto. These can be called by clicking on buttons above the monthly averages for the entire preceding year and the current month on the dashboard to take the user to the control charts and on each control chart to return the user to the dashboard.

The software dashboard can be updated by copying and renaming the workbook and then pasting the most recent year's worth of data time bucketed daily onto a Daily Data Year worksheet and time bucketed monthly into a Monthly Data Year worksheet. Next, the last month (most recent) of the Daily Data Year worksheet is pasted onto the Daily Data Month worksheet. This updates all of the control charts and dashboard metrics. Finally, a button to Refresh Scale and a button to Refresh Signal Processing Color should be clicked to update the dashboard graphics and cell colors.

Regarding the RDU, in one embodiment, the terms related to the system may be defined as follows:

Value is optionally defined as increased quality or decrease in overall cost of care.

Innovation is optionally defined as a new match between a need and a solution. The novelty can be in the solution, the need or the new marriage of the existing need and of the existing solution.

Implementation Science is optionally defined as the process of implementing evidence-based programs and practices (“EBP”) in the “real world.”

Research and Discovery Unit is optionally defined as a team that will act as internal consultants and work to accelerate the adoption of innovative health care solutions and evidence-based practices, and design processes that are systematic and replicable to improve patient outcomes and population health; this team will not be the implementers, they will act merely as consultants.

Variable Direct Cost Savings is optionally defined as the amount or percentage of the total variable direct cost that is controllable and can be impacted through process improvement activities.

Variation is optionally defined as the overall spread in costs, length of stay (“LOS”), mortality, readmissions, or other outcome metrics.

Acceptable or Warranted Variation is optionally defined as the spread in costs, LOS, mortality, readmissions, or other outcome metrics that exist below the mean.

Unacceptable or Unwarranted Variation is optionally defined as the spread in costs, LOS, mortality, readmissions, or other outcome metrics that exist above the mean.

Service is optionally defined as the RDU's ability to support and assist the customer in every way possible to help the customer meet or exceed their deliverable, without taking the credit.

Contract is optionally defined as an agreement between the RDU and its customer, detailing the type of service the RDU can provide to the customer to successfully meet its deliverable.

Referral is optionally defined as a new contract gained by the RDU through a past customer's recommendation based on the RDU's ability to successfully service the customer with its deliverable.

Physician Champion is optionally defined as a physician that will take the lead on a quality improvement project or initiative, with the goal being to bring together colleagues, get everyone on the same page and move forward in the direction needed.

Innovating in Africa is optionally defined as the innovation that occurs in limited resource environments.

Thus, herein presented is a computer implemented system for transforming a standard health care providing system into a learning health care system comprising: a process for engagement between a requester and a research and discovery unit, a process for providing research and discovery unit services before, during, and after implementation of the system, and a software dashboard providing metrics on improved costs to patients and health care providers, improved health of patients, and improved care offered by the health care providers and received by patients.

In a further embodiment, the process for engagement comprises at least one of one of a letter of inquiry, a diagnosis, and an initial consultation between the requester and the research and discovery unit.

In another embodiment, the research and discovery unit services comprise identification of opportunities for improvement within a health care system, critical review of an area where an opportunity for improvement exists, identification of a problem, identification of a current deficiency in the health care system, identification of personnel and methods needed to eliminate the deficiency in the health care system, identification of a desired state of the system, identification of evidence-based solutions to solve the problem, development of an implementation plan, creation of a communication plan, localization of an identified evidence-based solution, and creation of an evaluation plan.

In still another embodiment, the area is selected from the group consisting of: a service line, a hospital, a health plan, a doctor's office, a medical facility, an outpatient center, and a medical school.

In yet another embodiment, the research and discovery unit services further comprise a knowledge bank and a feedback loop.

Additionally presented is a method for transforming a standard health care providing system into a learning health care system comprising: providing a process for engagement between a requester and a research and discovery unit, providing research and discovery unit services before, during, and after implementation of the system, and utilizing a software dashboard providing metrics on improved costs to patients and health care providers, improved health of patients, and improved care offered by the health care providers and received by patients.

In one embodiment, the process for engagement comprises at least one of a letter of inquiry, a diagnosis, and an initial consultation between the requester and the research and discovery unit.

In another embodiment, the research and discovery unit services comprise identification of opportunities for improvement within a health care system, critical review of an area where an opportunity for improvement exists, identification of a problem, identification of a current deficiency in the health care system, identification of personnel and methods needed to eliminate the deficiency in the health care system, identification of a desired state of the system, identification of evidence-based solutions to solve the problem, development of an implementation plan, creation of a communication plan, localization of an identified evidence-based solution, and creation of an evaluation plan.

In still another embodiment, the area is selected from the group consisting of: a service line, a hospital, a health plan, a doctor's office, a medical facility, an outpatient center, and a medical school.

In yet another embodiment, the research and discovery unit services further comprise a knowledge bank and a feedback loop.

Also presented is a method of presenting data for continuous improvement in a health care system comprising: designing and installing a software dashboard for implementing learning health care systems, wherein the dashboard comprises: descriptions of health care metrics to be improved or maintained, current metrics data, metrics targets, users' goals with respect to the metrics targets, and graphics that display a current representation of a metric value relative to a metric's target value.

In one embodiment, the dashboard indicates the presence of a statistically significant trend in data.

In another embodiment, the dashboard is implemented in a spreadsheet workbook.

In still another embodiment, the dashboard further includes linked data worksheets and control chart worksheets.

In yet another embodiment, the dashboard further comprises macros for navigation among worksheets, macros for graphics displays, and macros for conditional formatting.

In still another embodiment, the dashboard uses x̅-charts plotting means and s-charts plotting standard deviations for continuous data, and p-charts plotting proportions and c-charts plotting count data.

Also presented is a method for transforming standard health care providing systems into learning health care systems comprising the steps of: providing a research and discovery unit to which requests can be made by requesters; scanning a client environment to identify possible opportunities for improvement; checking data to verify that an opportunity for improvement is real and that the research and discovery unit can impact the opportunity; searching a knowledge bank to determine if a solution exists that meets a triple aim of better care and better health at a lower cost, wherein if a preexisting solution exists, the research and discovery unit will localize the solution to meet the needs of the client's environment, and wherein if a preexisting solution does not exist, the research and discovery unit collaborates with a requester to invent a new solution; collaborating with the requester to implement either the preexisting solution or the new solution; and creating an evaluation plan and system to create a data feedback loop and give implementers signals of early success or failure so that the implementers can make appropriate corrections to the preexisting solution or the new solution.

In one embodiment, the step of collaborating with the requester further includes the steps of: (1) organizing teams; (2) facilitating teams; (3) innovating utilizing limited resources; (4) creating a communication plan; and (5) designing the workflow.

In another embodiment, at least one of the steps utilizes software to perform at least one task selected from the group consisting of: recording data, tracking data, statistically analyzing data, presenting data, validating data, searching a knowledge bank, localizing a solution, creating an evaluation plan and system to create a data feedback loop.

Additionally disclosed is a user interface displayed on a computer, comprising a first graphical representation of a performance metric including a target icon and a performance icon; a first indicia of a user-defined target value for the metric which is indicated by the target icon; and a second indicia of a user-defined goal with respect to the target value, the second indicia indicating one of above or below the target value; wherein when the second indicia indicates above the target value, a first orientation of the performance icon relative to the target icon indicates a first performance of the performance metric and a second orientation of the performance icon relative to the target icon indicates a second performance of the performance metric, the first performance indicating better performance relative to the goal than the second performance; and wherein when the second indicia indicates below the target value, the first performance indicates worse performance relative to the goal than the second performance.

In some embodiments, the user interface further includes a second graphical representation having a plurality of icons which display data associated with a location of the performance icon, the plurality of icons being actuatable by a user using an input device. In other embodiments, the performance icon includes a first color when the target value is substantially achieved, includes a second color when the target value is not substantially achieved, but is within a user-defined range of the target value, and includes a third color when the target value is not substantially achieved and is not within a user-defined range of the target value.

In some embodiments, the user interface includes a third graphical representation including at least one trend icon that indicates one of a positive statistically significant trend relative to the goal indicated by the second indicia, a negative statistically significant trend relative to the goal indicated by the second indicia, or no statistically significant trend relative to the goal indicated by the second indicia. In still other embodiments, the performance icon indicates a performance value selected from the group consisting of: a current monthly average value for the year of the performance metric; a current monthly average value of the performance metric; and a current weekly average value of the performance metric.

In other embodiments, actuation of one of the plurality of icons causes the interface to display a third graphical representation including additional data related to the actuated graphical representation.

### BRIEF DESCRIPTION OF THE DRAWINGS

The features of this disclosure, and the manner of attaining them, will become more apparent and the disclosure itself will be better understood by reference to the following description of embodiments of the disclosure taken in conjunction with the accompanying drawings.

FIG. 1 is a flow chart which illustrates an exemplary method whereby a RDU removes sources of variation from standard heath care systems and uses implementation science to transform standard health care systems into learning health care systems.

FIG. 2 is a block diagram which illustrates an exemplary process for engagement of an RDU.

FIG. 3 is a block diagram which illustrates an exemplary method for providing RDU services.

FIG. 4 is a flow chart which illustrates the steps in an exemplary method for a RDU to remove sources of variation from standard heath care systems and use implementation science to transform a standard health care system into a learning health care system.

FIGS. 5A-B illustrate a spread sheet table or worksheet in a workbook which illustrates an exemplary software dashboard or user interface for display on a computer.

FIG. 6 is a letter format which illustrates an exemplary format for a letter of inquiry.

FIGS. 7-10 are check list formats which illustrate an exemplary format for RDU checklists.

FIG. 11 is a memorandum format which illustrates an exemplary format for a memorandum of understanding.

FIGS. 12, 13 show fields which illustrate exemplary evaluation fields for a RDU team.

FIG. 14 shows fields which illustrate exemplary evaluation fields for a reflective adaptive process implementation team.

FIGS. 15-18 show fields which illustrate exemplary evaluation fields for a RDU complex adaptive system evaluation matrix.

Corresponding reference characters indicate corresponding parts throughout the several views. Although the drawings represent embodiments of the present disclosure, the drawings are not necessarily to scale and certain features may be exaggerated in order to better illustrate and explain the present disclosure. The exemplifications set out herein illustrate an exemplary embodiment of the disclosure, in one form, and such exemplifications are not to be construed as limiting the scope of the disclosure in any manner.

### DETAILED DESCRIPTION OF THE DRAWINGS

The embodiments disclosed herein are not intended to be exhaustive or limit the disclosure to the precise form disclosed in the following detailed description. Rather, the embodiments are chosen and described so that others skilled in the art may utilize their teachings.

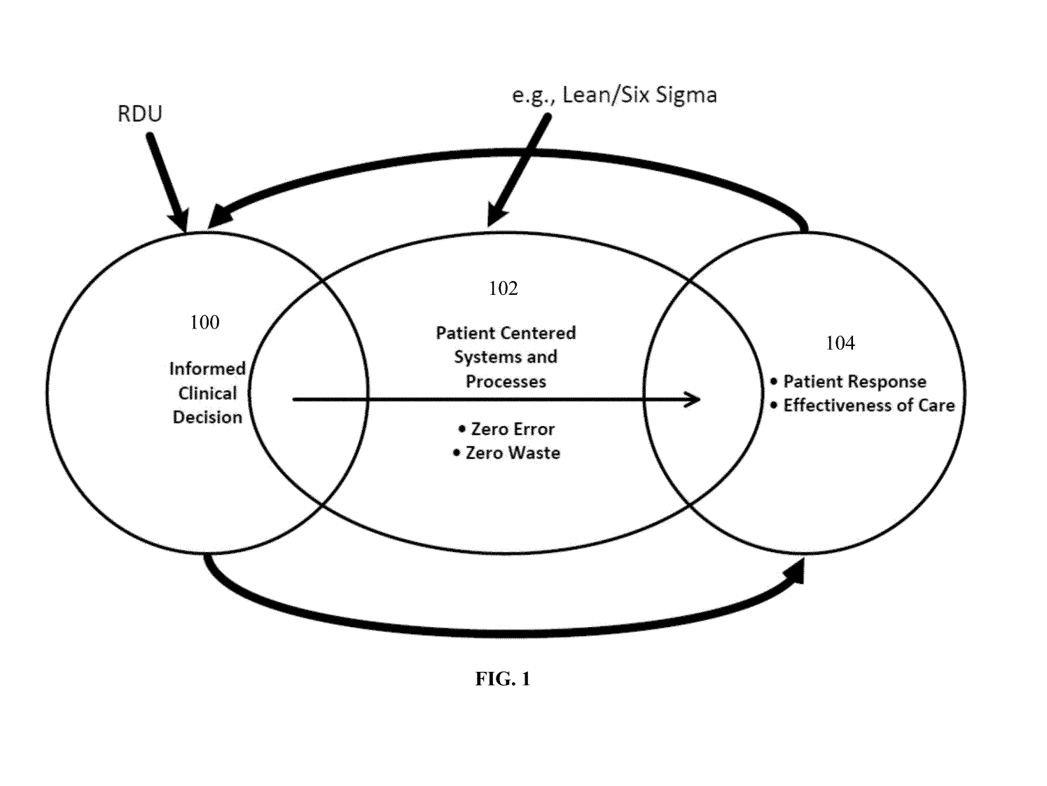

Referring first to FIG. 1, an exemplary method whereby an RDU removes sources of variation from standard heath care systems and uses implementation science to transform standard health care systems into learning health care systems is provided. The RDU guides informed clinical decisions to result in effective patient response and improved effectiveness of care. By using patient centered systems and processes and Lean and/or Six Sigma, error and waste are eliminated.

FIG. 1 shows three sources of variation that occur in health care. The starting point for these sources of variation can be described as the initial contact that a patient makes with a health care provider such as an individual clinician, more than one clinician, a hospital, a clinic or any person working at a location (virtual or physical) in which the primary role and responsibility is to provide care to patients. This starting point lies within Informed Clinical Decision domain 100. Informed Clinical Decision domain 100 encompasses all aspects of care that are performed before an actual order is made for treatment. The variation that exists within domain 100 is the variation that implementation science seeks to improve. Implementation science tries to reduce inappropriate variation in Informed Clinical Decision domain 100 by providing clinicians with evidence-based medicine, practices, treatments and protocols, as well as localizing and implementing the evidence-based medicine, practices, treatments and protocols.

The second source of variation occurs in Patient Centered Systems and Processes domain 102. The variation for domain 102 starts after a clinician has prescribed an order for treatment to the patient and his/her care team. Lean and/or six sigma methodologies can be successful at reducing unnecessary variations. The variations that occur in Patient Centered Systems and Processes domain 102 are all process oriented and can be likened to processes that occur within a manufacturing system. The goal of reducing variation for domain 102 is the ability to deliver the right treatment, at the right time, in the right place to the right patient with zero errors and zero waste.

The third source of variation occurs in Patient Response domain 104. This variation refers to the variation that exists within each individual's DNA and the environment in which they live and work in. If all of the inappropriate and unnecessary variation was taken out of Informed Clinical Decision domain 100 and Patient Centered Systems and Processes domain 102, the variation in Patient Response domain 104 would still exist and in some cases cannot be controlled or altered.

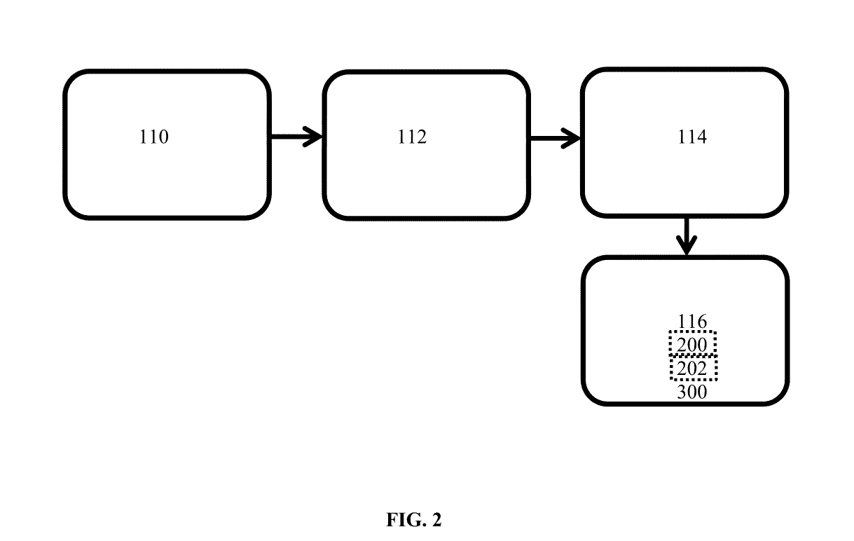

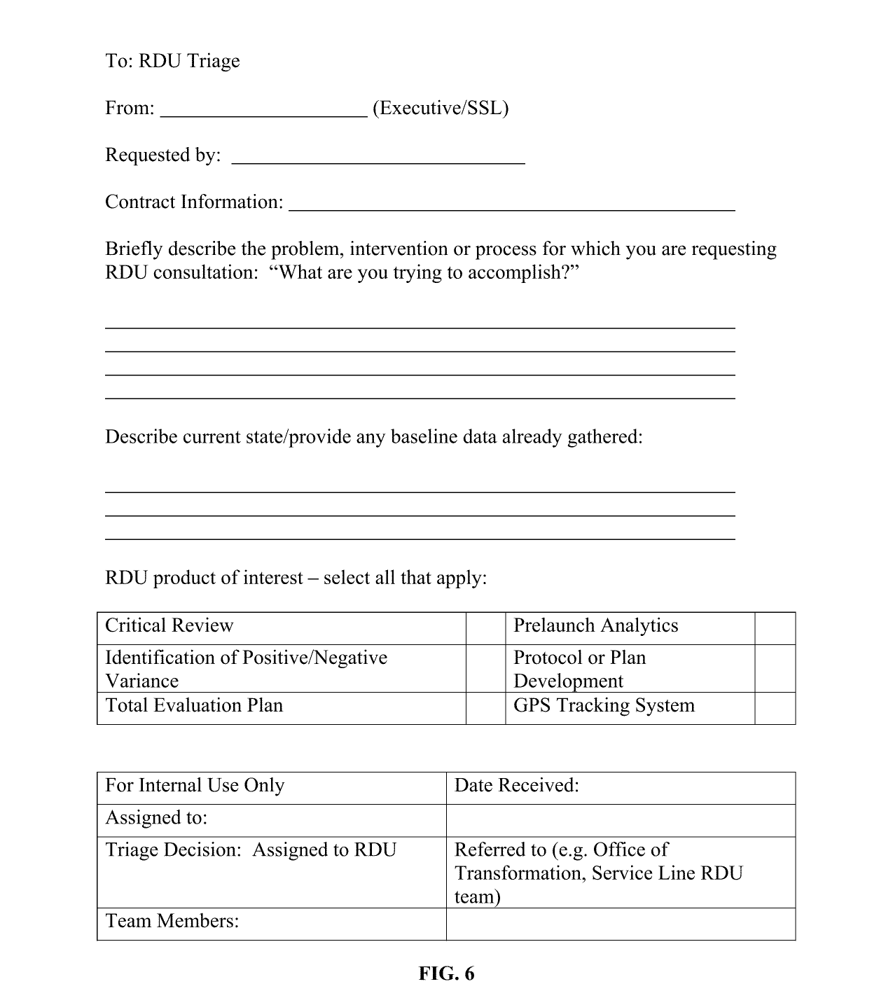

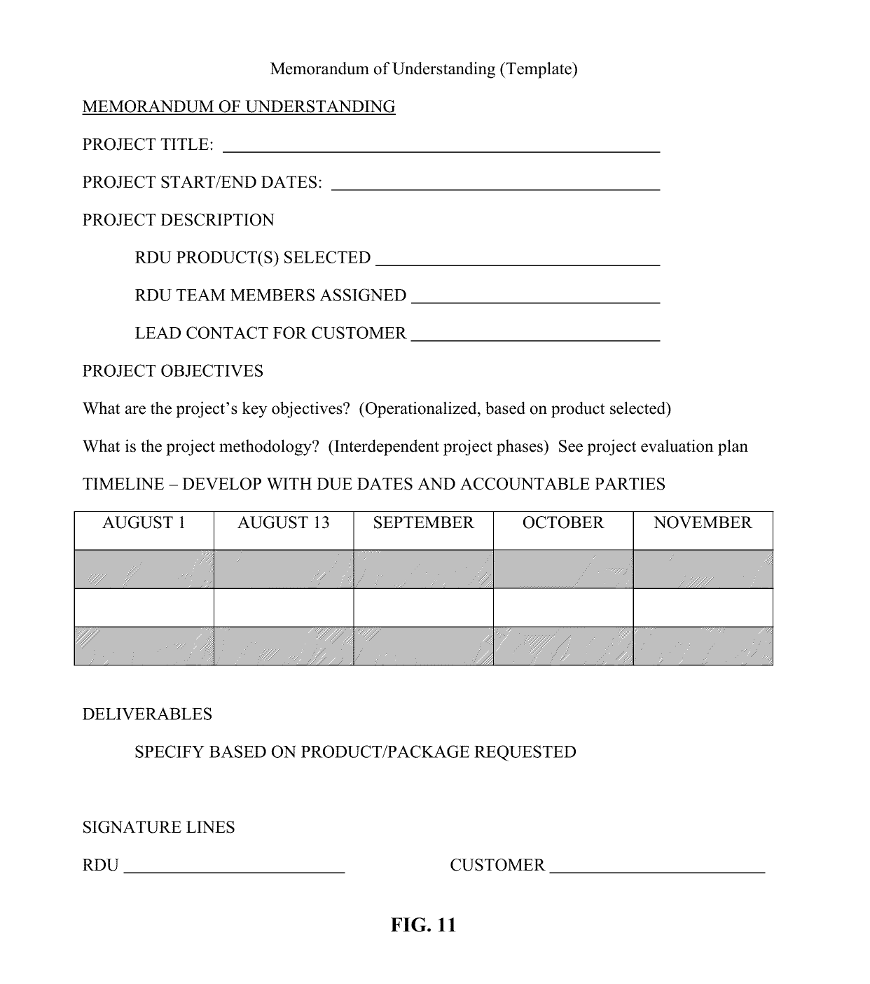

Referring now to FIG. 2, a block diagram which illustrates an exemplary process for engagement is provided. In one embodiment, the process begins when a letter of inquiry or similar request is made at step 110. An exemplary letter of inquiry is shown in FIG. 6. Next, following the letter of inquiry, a diagnosis at step 112 is performed wherein the RDU team will provide a critical assessment of the customer's scope of work, and as a result of the critical assessment and preliminary evaluation, the RDU team will develop initial findings, which will be documented in a “Memorandum of Understanding” or similar memorandum. An exemplary memorandum is shown in FIG. 11.

After diagnosis at step 112, an initial consultation at step 114 is performed, where in one embodiment, the RDU team will schedule an initial face-to-face meeting with the customer's leadership team to present the preliminary findings for review and discussion. After the initial consultation at step 114, the process for engagement comes to a close and RDU services begin with identification of large opportunities for improvement within a health care provider at step 116.

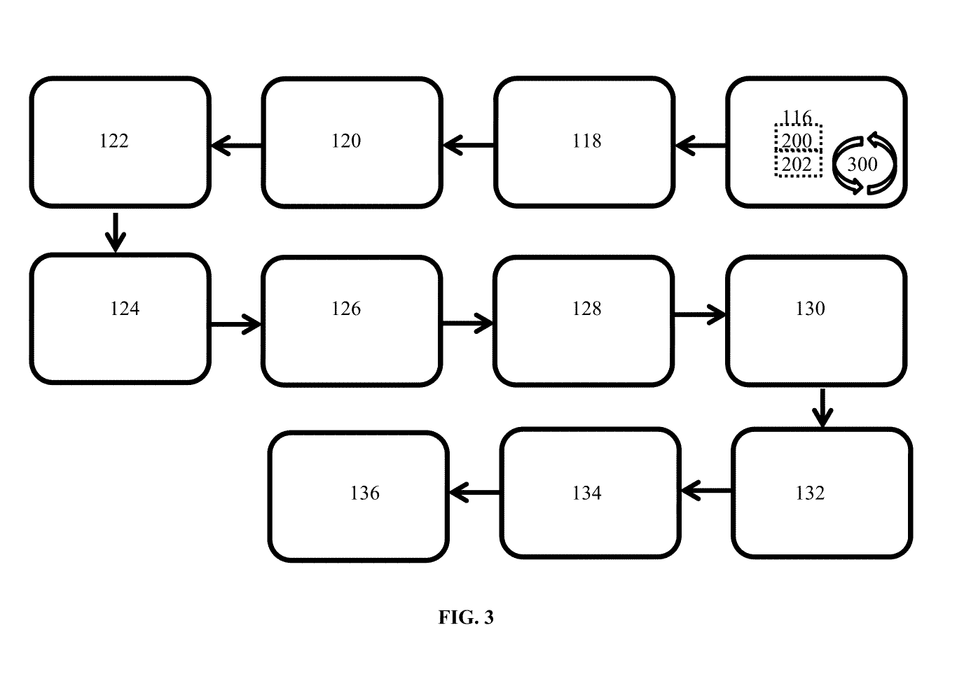

Referring now to FIG. 3, a block diagram which illustrates an exemplary method for providing RDU services is shown. In one embodiment, the RDU provides identification of large opportunities for improvement within a health care provider system at step 116 using one or more of: a software dashboard or user interface 200, displayed on a computer, as a system-level annual performance tool; continuous scanning of national health care initiatives; annual systematic review of the published literature for innovative health care solutions; annual strategic meetings with RDU chief innovation and implementation officers; and physician feedback via periodic, possibly monthly, innovation forums.

The RDU provides critical review of areas at step 118, including areas such as service lines, hospitals, health plans or other areas where an opportunity for improvement might exist. The critical review of areas in one embodiment includes critical assessment, critical feedback, and critical advice.

The RDU also provides identification of the problem at step 120 and transforms the problem into an operational question(s). The RDU further provides identification of the current state of a gap or deficiency in a health care provider system or operation at step 122 and works with decision support or a data warehouse team to verify that a problem actually exists.

The RDU also provides identification of who (personnel) and what (methodology or equipment) is needed to fill the current state of a gap or deficiency in a health care provider system or operation at step 124.

The RDU further provides identification of the future state or a desired state for the health care provider at step 126 by working with project team members to clearly and objectively develop metrics that define what success looks like and by working with decision support or a data warehouse team to identify and gather the data needed to populate those metrics.

The RDU next provides identification of evidence-based solutions at step 128 to solve the problem. The RDU might check internal and external knowledge banks to determine if others have tried to solve this problem before and learn from past failures or successes to accelerate the solution identification process. Additionally, the RDU may check the literature to determine if an evidence-based solution exists that delivers the triple aim. If a solution does not exist, the RDU may organize an innovation forum to innovate and invent a new solution.

The RDU of the exemplified embodiment also develops an implementation plan at step 130. The implementation plan developed at step 130 optionally will consist of strategies, resources, and skill sets needed to successfully implement the interventions identified for improvement.

Next, the exemplified RDU creates a communications plan at step 132, which optionally may comprise the following elements: (1) recommended tactics for communicating and soliciting feedback and educating physicians and staff; (2) information about the target audience; (3) the goals; (4) information the audience needs to buy-in to and how this will be measured; (5) meaningful actions that need to be taken; (6) strategy; (7) key messages to primary and secondary audiences; (8) a particular communication tone; (9) particular communication channels; (10) reinforcing materials (e.g. letters, pocket cards, posters); (11) interactive communication tactics (e.g. Lunch and Learns); and (12) reinforcing communication tactics (e.g. townhalls).

Additionally, the RDU provides localization of the identified evidence-based solution at step 134. Optionally, this may comprise: (1) setting the minimum specified criteria for the care delivery model; (2) identifying if other resources are needed to implement the solution; and (3) engaging in multiple rapid cycle experimentations to update the solution identified and ensure that it meets the needs of the local environment to deliver the triple aim.

Finally, the RDU provides creation of an evaluation plan at step 136, wherein the evaluation plan optionally comprises: (1) pre-launch analytics and a GPS tracking system, wherein there is the ability to provide content experts and implementers an early signal for success or failure (failure reduction) and to detect when their solution/intervention is heading in the wrong direction by using current data, knowledge banks, queries and focus groups to make the necessary course corrections; (2) a protocol or analytic plan to monitor if the solution is producing the triple aim; and (3) a plan that specifically defines the metrics that will be used to determine failure, success and the evaluation process, as well as an appropriate timeframe to decide whether or not the solution or intervention worked.

Over time, the RDU will optionally create a knowledge bank 202 including solutions that have been implemented at the health care provider or across multiple health care providers to solve various problems. Knowledge bank 202 will allow users to quickly discover if a solution was a failure or success. Knowledge bank 202 will act as a health care provider's memory in its transformative journey in becoming a learning health care system. Additionally, knowledge bank 202 will accelerate the problem and solution identification process for health care providers. Data in knowledge bank 202 may be stored in any electronic database and/or cloud-based database known in the art.

The RDU will optionally work with the health care provider's executives and implementers to create real-time data feedback loops 300 that are capable of producing actionable, objective information that will help implementers and physicians modify their interventions and practices accordingly to deliver the best value for their patients and meet the needs of both population health management and personalized medicine.

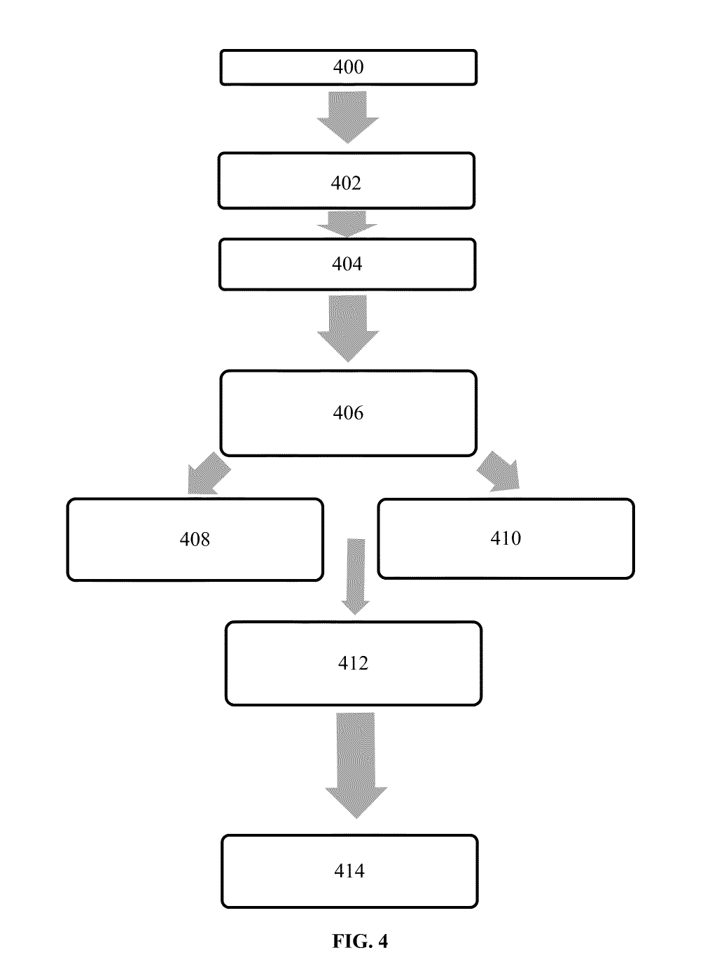

Referring now to FIG. 4, a flow chart which illustrates the steps in an exemplary method for a RDU to remove sources of variation from standard heath care systems and use implementation science to transform a standard health care system into a learning health care system is provided. At step 400, a request is made by a client, customer, implementer, or executive to a RDU. At step 402, the RDU scans the client's environment to identify possible opportunities (e.g. results in >$5M in cost savings or new revenue generation per year) for improvement. At step 404, the RDU checks the data to verify and validate that the opportunity is real and that the RDU can actually impact the opportunity. This step is optionally performed with software.

Next, at step 406, the RDU searches a knowledge bank to determine if a solution exists that meets the triple aim of better care and better health at a lower cost. This step is optionally performed with software. At step 408, if a solution exists, the RDU will localize the solution to meet the needs of the client's environment. This step is optionally performed with software. If a solution does not exist, at step 410 the RDU works with the client to invent a new solution.

Next at step 412, the RDU works with the client to implement the solution. This optionally includes (1) organizing teams; (2) facilitating teams; (3) innovating utilizing limited resources; (4) creating a communication plan; and (5) designing the workflow. Finally, at step 414 the RDU creates an evaluation plan and GPS system to create a data feedback loop and give the implementers signals of early success or failure so that the implementers can make the appropriate course corrections. This step is optionally performed with software.

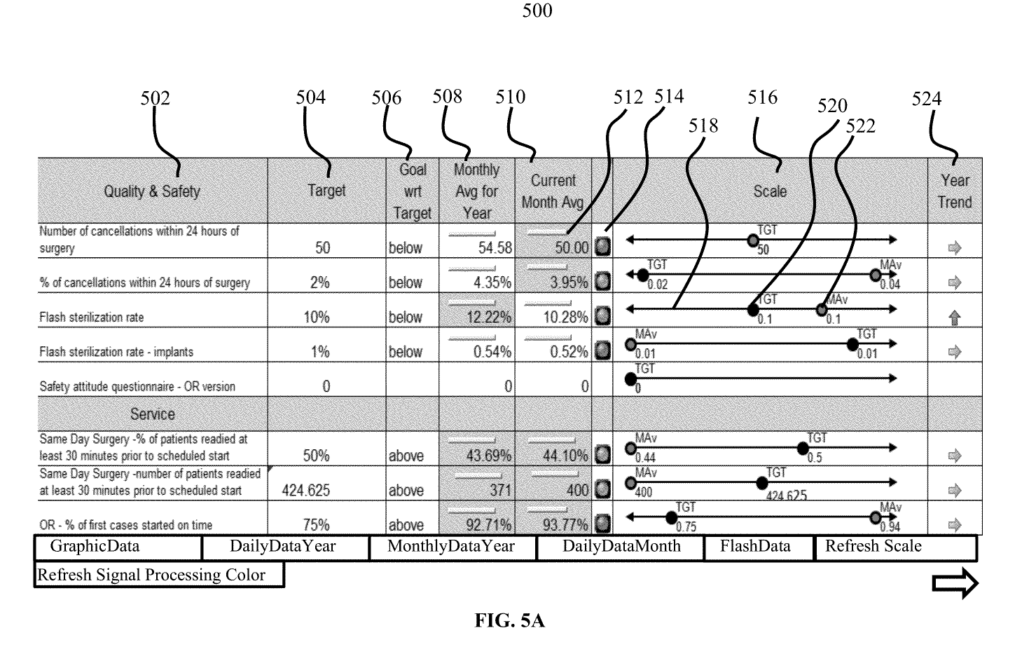

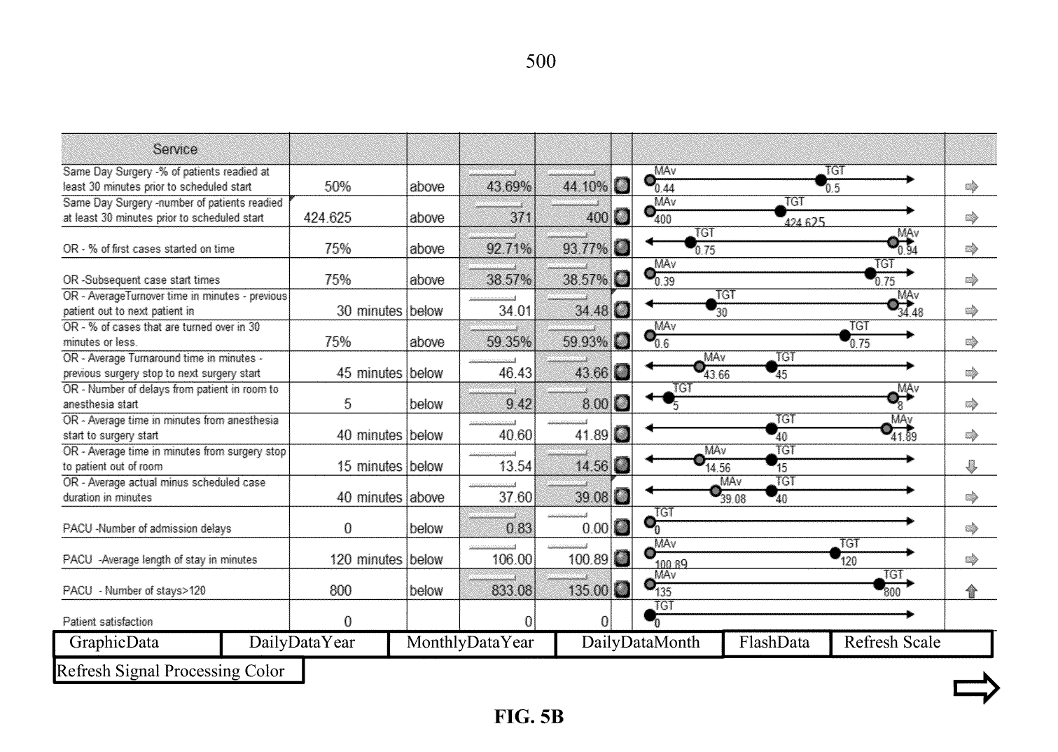

Referring now to FIGS. 5A-B, spreadsheet table 500, illustrating an exemplary software dashboard or user interface, for display on a computer or other special purpose computing device, is shown. Column 502 of the worksheet contains descriptions of exemplary metrics for monitoring within the RDU. Any other metrics for monitoring requested by a requester or recommended by the RDU could also be tracked in spreadsheet table 500. Target column 504 allows target values to be entered by the user. Goal with respect to target column 506 allows the user to enter whether the goal is for the metric value to be above or below the target.

Monthly Average for Year column 508 and Current Month Average column 510 contain the monthly averages for the entire preceding year and the current month, respectively. These metrics are taken from related control charts either in the same workbook or other linked spreadsheet workbooks, and the cells contain formulas linking them to the appropriate control chart cells. Above each average value is an actuatable button 512 on which a user can click, which takes the user to the worksheet with the related control chart(s) for the displayed value.

Actuable buttons above the values in Monthly Average for Year column 508 take the user to a control chart for the past year with the data time bucketed by month. Buttons above the Current Month Average in column 510 take the user to a control chart for the immediately past month with the data time bucketed by day. The macros associated with these buttons can be accessed through the Code section of the Developer tab in Excel, or similarly in other spreadsheet programs. In one embodiment, the names of all macros for moving among worksheets begin with the letters goto.

The cells in Monthly Average for Year and Current Month Average columns 508, 510 are colored if the control charts show any nonrandom behavior as indicated by signal processing rules, for example those shown in Tables 2 and 3. This alerts the user to possible nonrandom events. The coloring is done by a macro called main_signal which takes data from a Signal_process_data section of a GraphicData worksheet. The Signal_process_data is optionally defined in the name manager on the formulas tab of Excel as the cells G4:G24 of the GraphicData worksheet. These cells are populated by formulas linking them to the signal processing data in the control chart worksheets. The cell coloring can be refreshed when the data is changed by clicking on a Refresh Signal Processing Color button optionally placed below the last metric on the dashboard.

Stoplight column 514 contains a stoplight that is a first color if the target value is achieved, a second color if the target value is not achieved but within 5% of target value, and a third color if the target value is not achieved and is outside of 5% of target value. Other values such as, for example, 10% and 15% could also be used. The first color, second color, and third color optionally are green, yellow, and red, respectively. As would be apparent to one skilled in the art, indicia other than color (i.e., orientation, direction, readable messages, symbols, and/or other indicia) may be used. Column 514 contains a formula for the difference between the current month average value and the target value and is conditionally formatted according to the rule for stoplight colors.

Scale column 516 provides one exemplary graphical representation of where the current month average value from column 512 is presently located relative to the target value in column 504, optionally with the same color scheme as the stoplights in column 514. The graphic in scale column 516 is created by a macro named main_slider. This macro draws line 518 in the scale column for each metric and positions a target icon 520, illustratively shown as a black dot, for the target value and a performance icon 522, illustratively a colored dot (for example, red, yellow, or green according to the above stoplight logic rules), for the current month average relative to each other on line 518 with the values to two decimal places underneath. In other embodiments, target icon 520 can be configured to display the monthly average for year value from column 508 relative to target icon 520. In some embodiments, both values from columns 508 and 510 could be displayed simultaneously in scale column 516 on line 518 relative to target icon 520 for a given metric from column 502.

A user interface displayed on a computer, such as for example spreadsheet table 500, can include any first graphical representation of a performance metric including a target icon, such as icon 520, and a performance icon, such as icon 522. Other representations of target icons and performance icons may be non-linear, colored, animated, and/or present audible indications, to name a few.

A first indicia of a user-defined target value for the metric from column 504 is indicated by target icon 520. A second indicia of a user-defined goal with respect to the target value from column 506, the second indicia indicating one of above or below the target value, is also provided. When the second indicia indicates above the target value, a first orientation of performance icon 522 relative to target icon 520 indicates a first performance of performance metric 522, and a second orientation of performance icon 522 relative to target icon 520 indicates a second performance of the performance metric, the first performance indicating better performance relative to the goal from column 506 than the second performance. When the second indicia indicates below the target value from column 504, the first performance indicates worse performance relative to the goal than the second performance.

The Main_slider macro takes data from a slider_param section of the GraphicData worksheet. The name slider_param is defined in the name manager on the formulas tab of Excel as the cells C4:F24 of the GraphicData worksheet. These cells are populated by formulas linking them to the dashboard worksheet. The graphic in scale column 516 can be refreshed when the data is changed by clicking on a Refresh Scale button below the last metric on the dashboard.

Year Trend column 524 indicates whether or not there is a statistically significant trend in the yearly control chart. In one embodiment, an up arrow of a first color [symbol] indicates statistically significant improvement, a down arrow of a second color [symbol] indicates a statistically significant decline, and a sidewise arrow of a third color [symbol] indicates no statistically significant trend. The rules to determine a trend for a goal to go below a target value are shown above in Table 3. The rules for the goal to go above a target value are analogous. Other visual and/or audible indicators of statistically significant trends could also be used, such as positive sounds or warning sounds.

The cells in trend column 524 contain formulas linking them to the trend sections of the related control chart worksheets where the trend logic is contained. They are conditionally formatted based on the value in the cell.

The macro main_signal colors the cells in Monthly Average for Year column 508 and Current Month Average column 510 blue, or another first color, if the control charts show any nonrandom behavior as indicated by the signal processing rules. The macro main_signal takes data from the Signal_process_data section of the GraphicData worksheet. The Signal_process_data is defined in the name manager on the formulas tab of Excel as the cells G4:G24 of the GraphicData worksheet. These cells are populated by formulas linking them to the signal processing data in the control chart worksheets. The cell coloring can be refreshed when the data is changed by clicking on a Refresh Signal Processing Color button below last metric on the dashboard.

The dashboard can be updated by copying and renaming the workbook and then pasting the most recent year's worth of data time bucketed daily onto the DailyDataYear worksheet and time bucketed monthly into the MonthlyDataYear worksheet. Next, the last month (most recent) of the DailyDataYear worksheet is pasted onto the DailyDataMonth worksheet. This updates all of the control charts and dashboard metrics. Finally, the button to Refresh Scale and the button to Refresh Signal Processing Color should be clicked to update the dashboard graphics and cell colors.

Referring now to FIG. 6, a letter format which illustrates an exemplary format for a letter of inquiry is provided. FIG. 6 provides one potential organizational format for a requester to request improvement from an RDU. More or fewer products of interest could be provided for the requester to request, and/or these could be provided to the requester in different formats. Such a letter may be provided to a requester and sent to an RDU by software, through a database, by emails, and/or by any other electronic means known in the art.

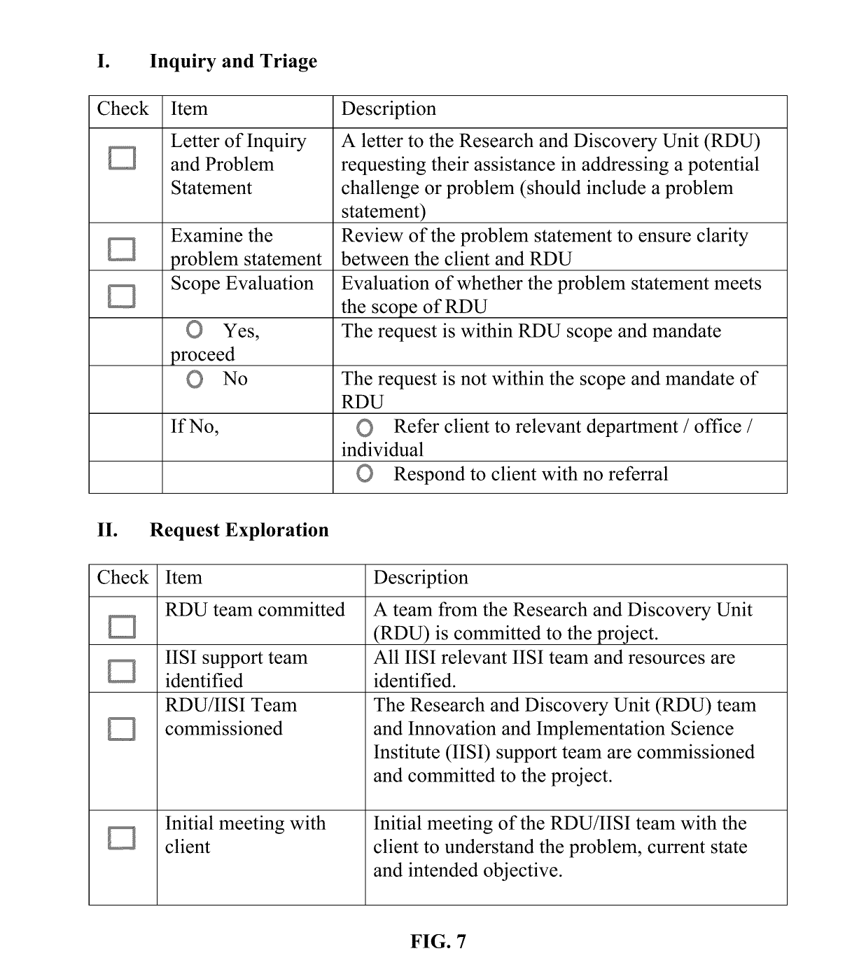

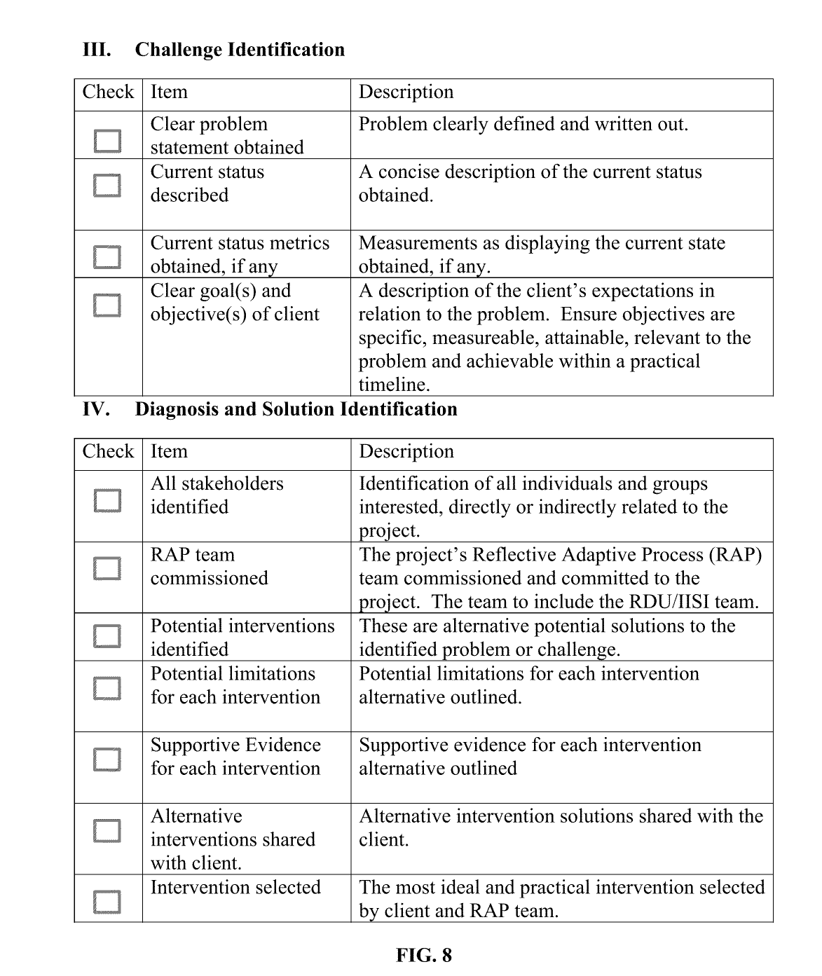

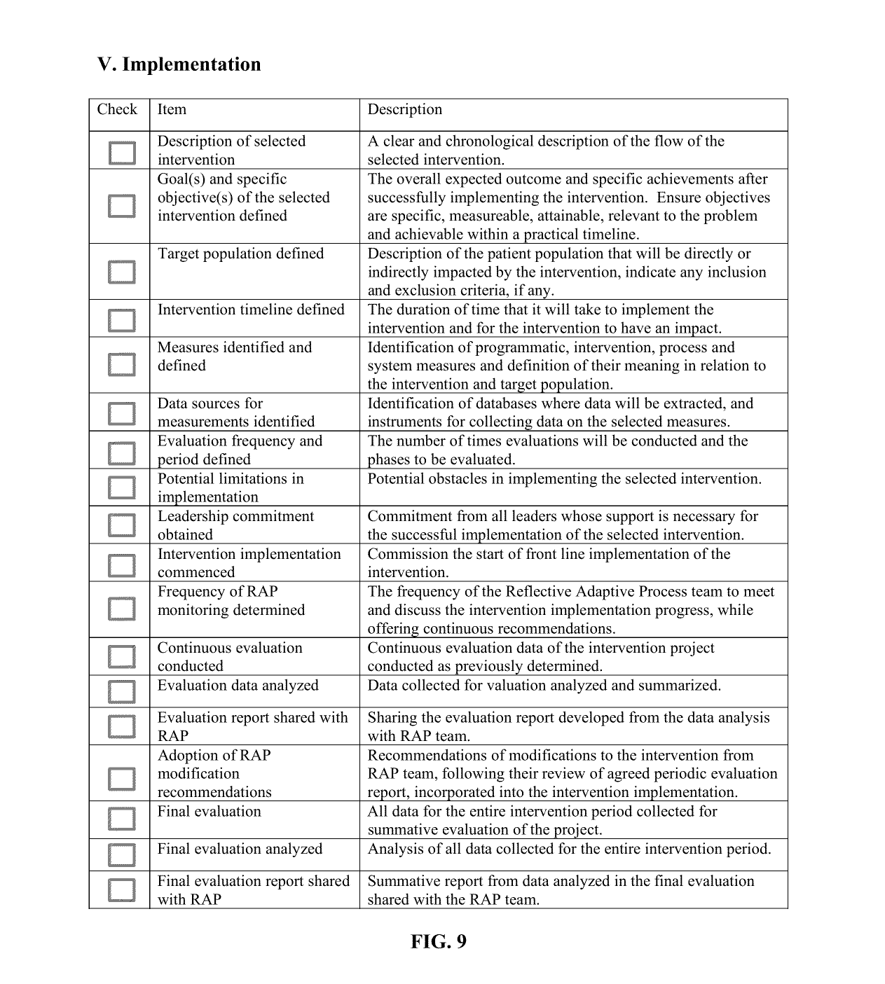

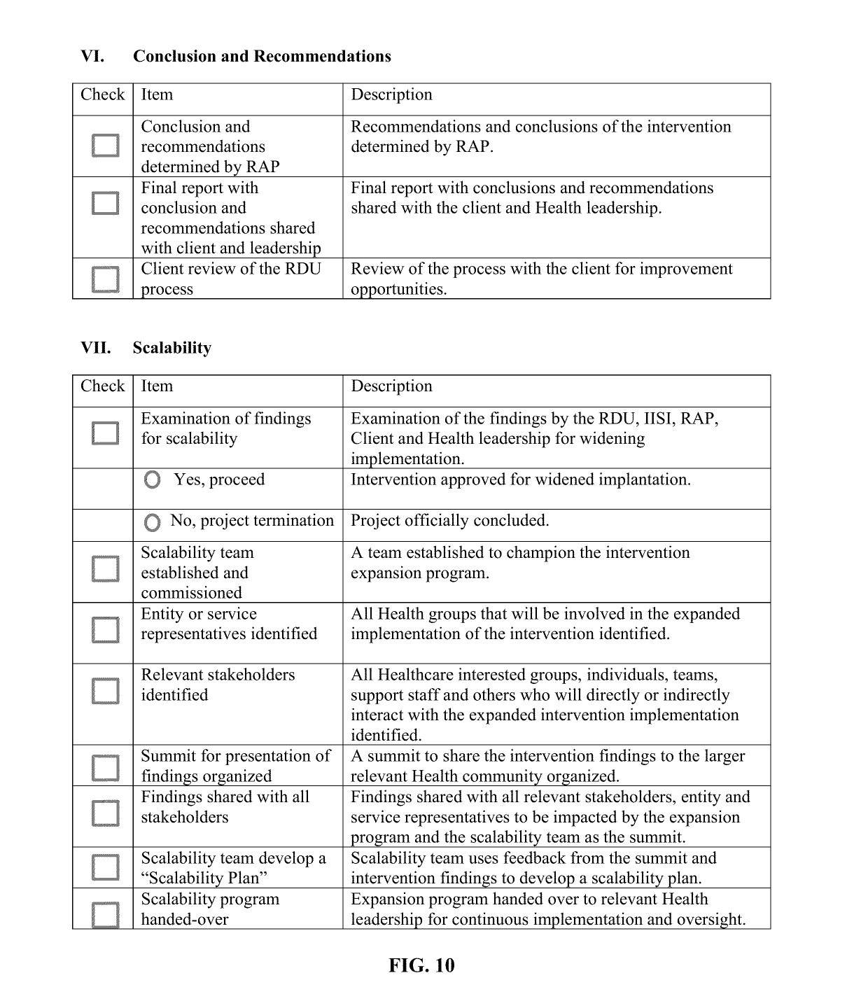

FIGS. 7-10 are check list formats which illustrate an exemplary format for RDU checklists. In the exemplary embodiment shown, the RDU process is divided into the following stages: (I) Inquiry and Triage; (II) Request Exploration; (III) Challenge Identification; (IV) Diagnosis and Solution Identification; (V) Implementation; (VI) Conclusion and Recommendations; and (VII) Scalability. The RDU process may, in other embodiments, be divided into more or fewer stages. Additionally, the format and information presented by the checklists may be different and include more or fewer options.

Referring now to FIG. 11, a memorandum format which illustrates an exemplary format for a memorandum of understanding is shown. Following the letter of inquiry or similar request, the RDU team will provide a diagnosis or critical assessment of the customer's scope of work, and as a result of the critical assessment and preliminary evaluation, the RDU team will develop initial findings, which will be documented in a memorandum of understanding (“MOU”) or similar document. The critical assessment provides a critical review of the information provided in the letter of inquiry or similar inquiry. Other formats for the MOU can be utilized, and such a memorandum could be presented on a computer or other electronic medium.

In one embodiment, after the critical assessment, the RDU team will schedule an initial face-to-face meeting or initial consultation with the customer's leadership team to present the preliminary findings for review and discussion. Revisions to and finalization of the MOU will outline the parameters for ongoing work between the RDU and the customer.

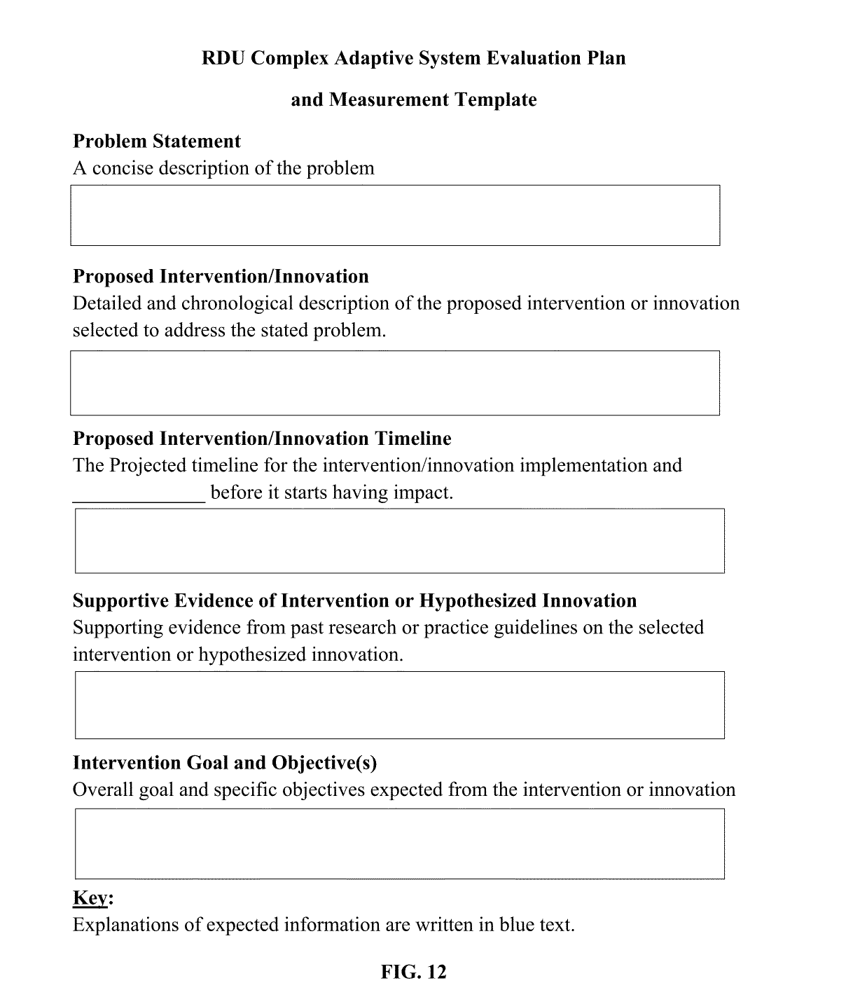

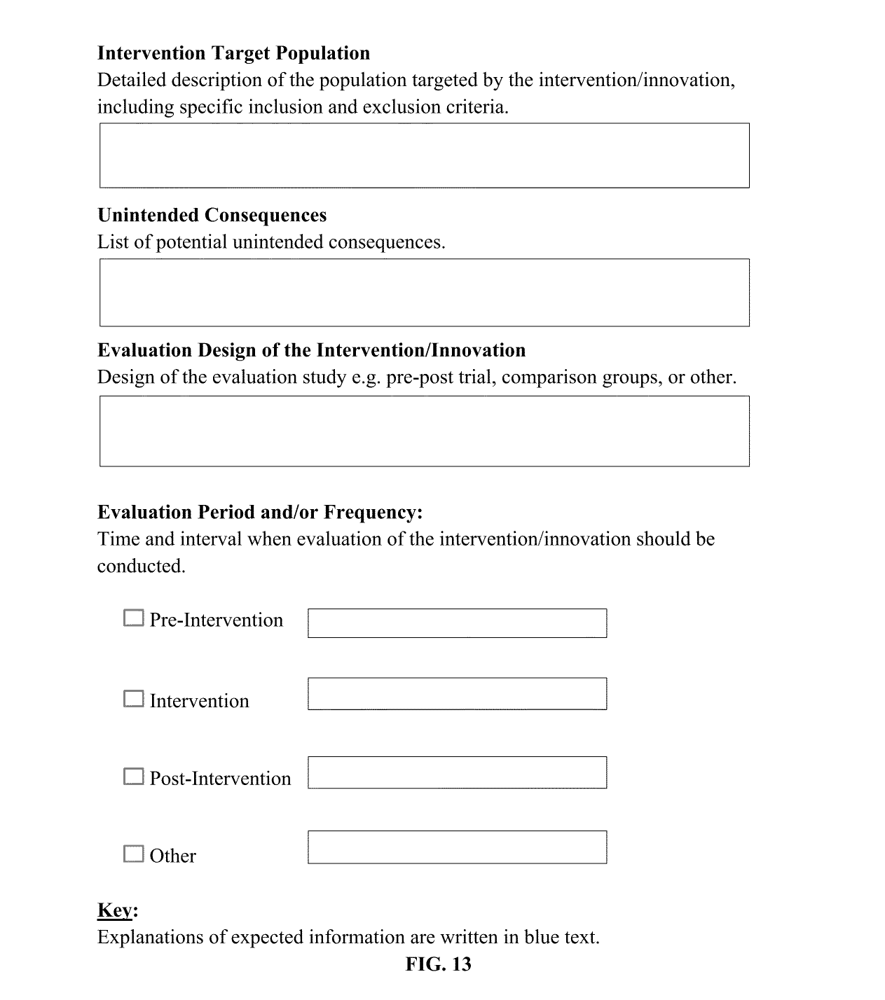

Referring now to FIGS. 12, 13, entry fields which illustrate exemplary evaluation fields for a RDU team are shown. More or fewer fields could be utilized in the format shown or a different format(s) depending on the information needed to be entered by the RDU.

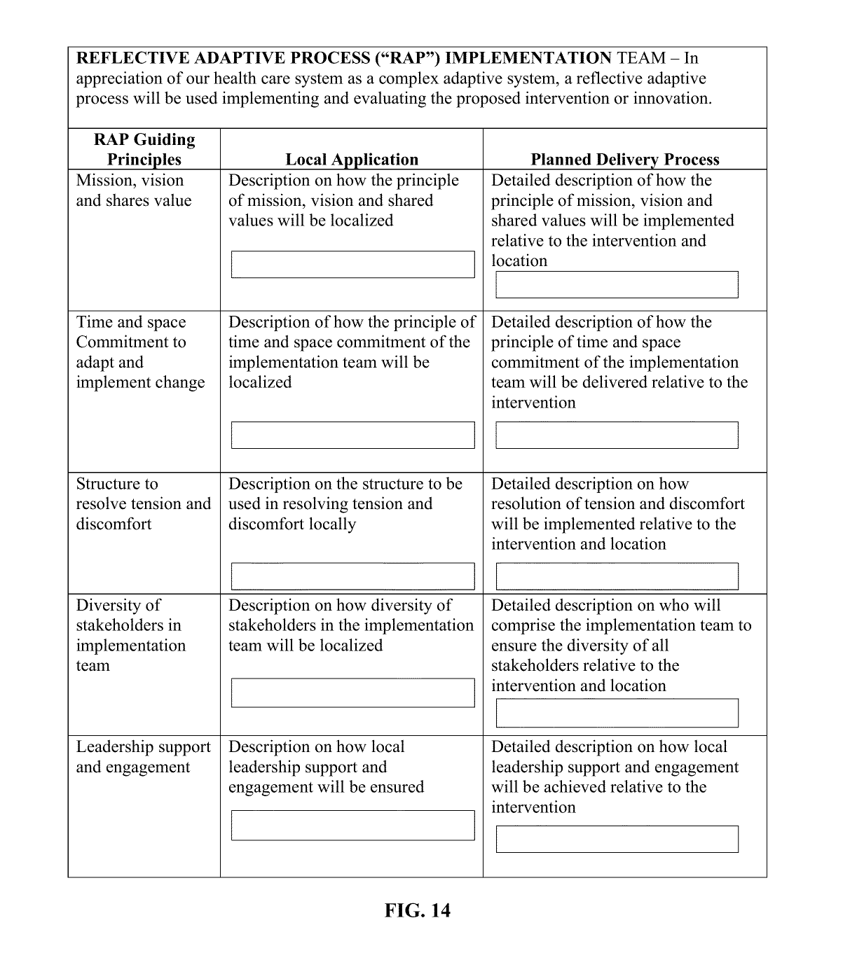

Referring now to FIG. 14, fields which illustrate exemplary evaluation fields for a reflective adaptive process implementation team are shown. A reflective adaptive process (“RAP”) is one exemplary means by which an RDU can implement a proposed intervention or innovation. Other formats/templates could be used for the RAP form requiring more or fewer inputs.

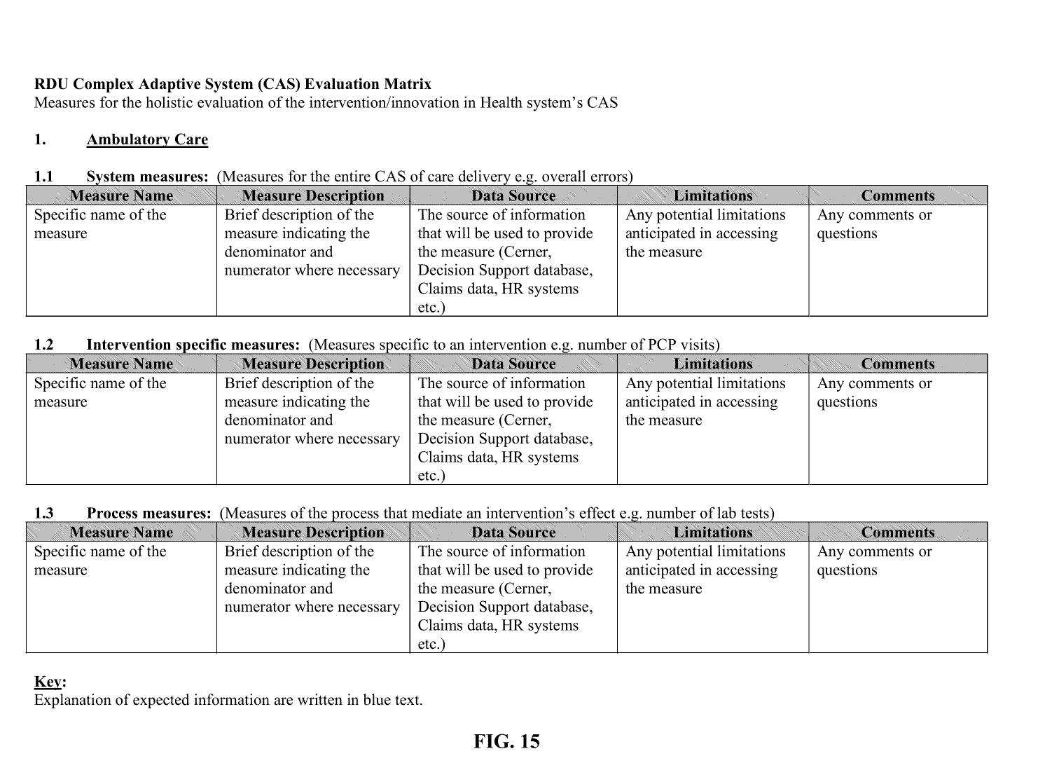

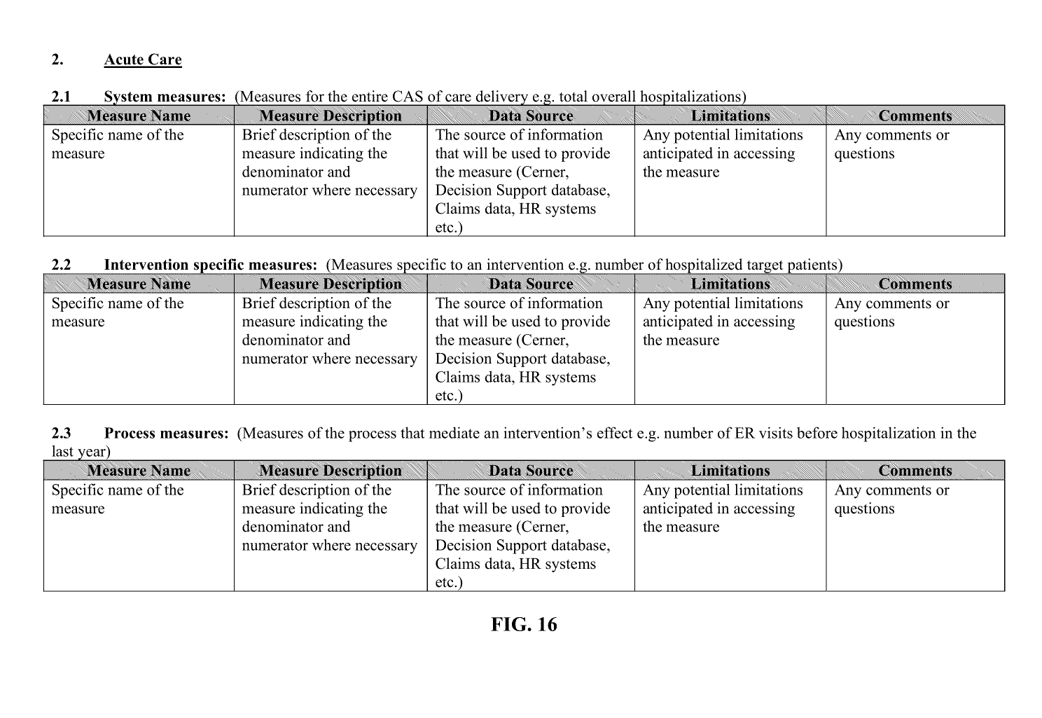

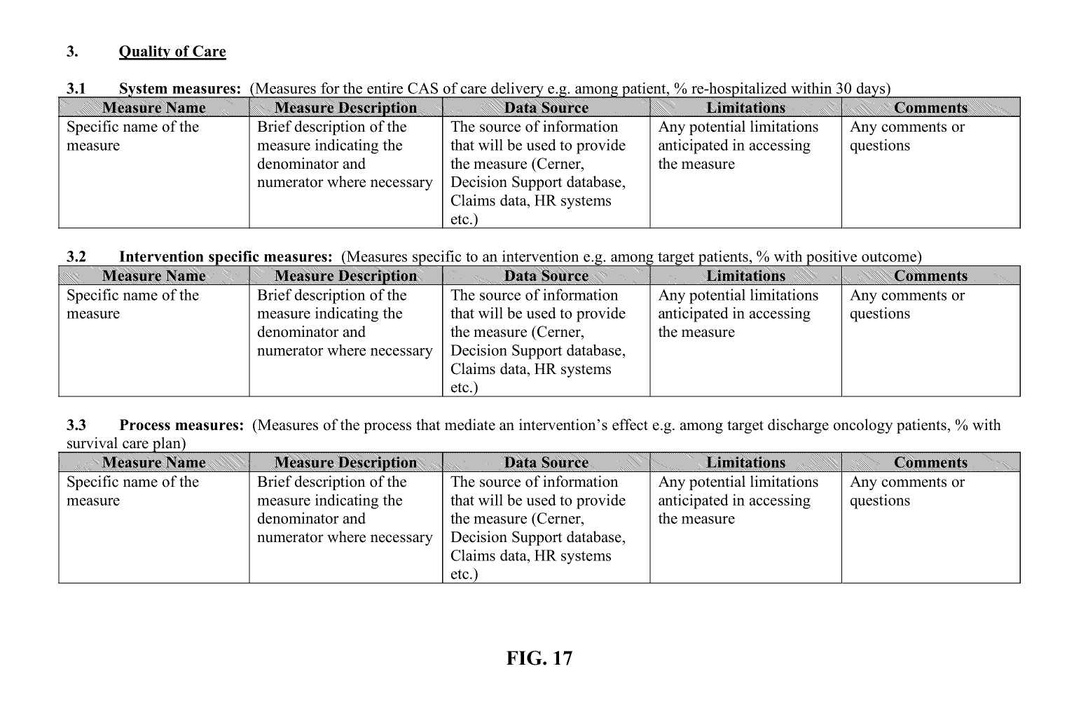

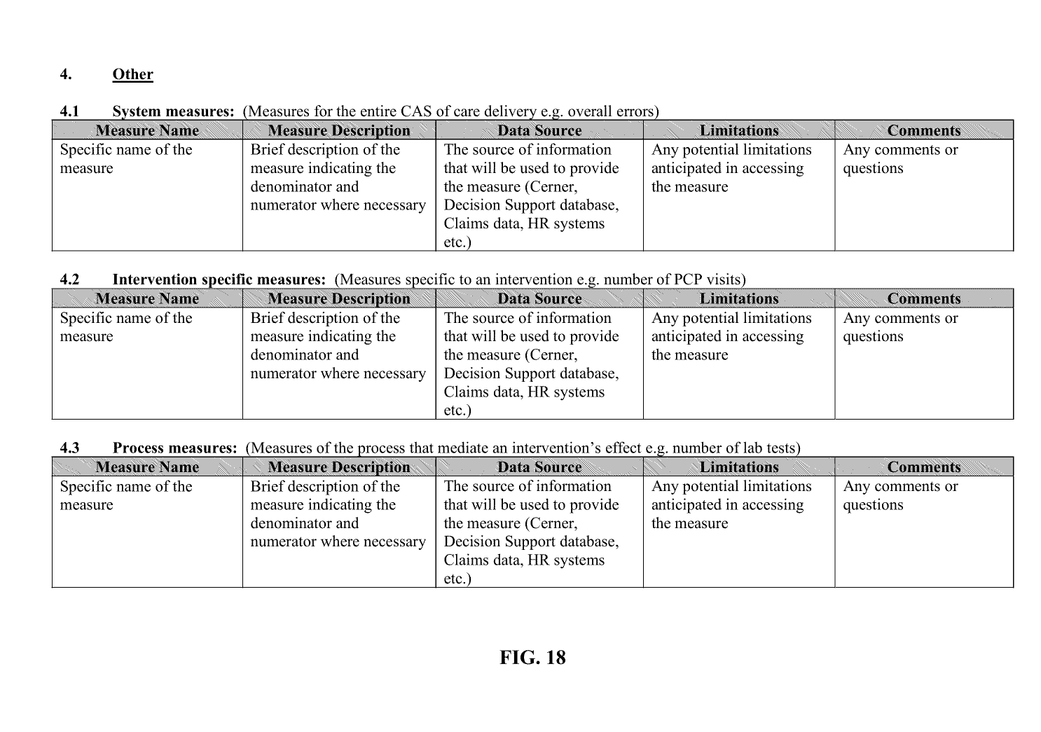

Referring now to FIGS. 15-18, fields which illustrate exemplary evaluation fields for a RDU complex adaptive system (“CAS”) evaluation matrix are shown. Other formats requiring entry of more or fewer measures could be utilized, optionally with any electronic means known in the art.

While the novel technology has been illustrated and described in detail in the figures and foregoing description, the same is to be considered as illustrative and not restrictive in character, it being understood that only the preferred embodiments have been shown and described and that all changes and modifications that come within the spirit of the novel technology are desired to be protected. As well, while the novel technology was illustrated using specific examples, theoretical arguments, accounts, and illustrations, these illustrations and the accompanying discussion should by no means be interpreted as limiting the technology. All patents, patent applications, and references to texts, scientific treatises, publications, and the like referenced in this application are incorporated herein by reference in their entirety.

What is claimed is:

1. A user interface displayed on a computer, comprising:
a first graphical representation of a performance metric including a target icon and a performance icon;
a first indicia of a user-defined target value for the metric which is indicated by the target icon; and
a second indicia of a user-defined goal with respect to the target value, the second indicia indicating one of above or below the target value;
wherein when the second indicia indicates above the target value, a first orientation of the performance icon relative to the target icon indicates a first performance of the performance metric and a second orientation of the performance icon relative to the target icon indicates a second performance of the performance metric, the first performance indicating better performance relative to the goal than the second performance; and
wherein when the second indicia indicates below the target value, the first performance indicates worse performance relative to the goal than the second performance.

2. The user interface according to claim 1, further including a second graphical representation having a plurality of icons which display data associated with a location of the performance icon, the plurality of icons being actuatable by a user using an input device.

3. The user interface according to claim 1, wherein the performance icon includes a first color when the target value is substantially achieved, includes a second color when the target value is not substantially achieved, but is within a user-defined range of the target value, and includes a third color when the target value is not substantially achieved and is not within a user-defined range of the target value.

4. The user interface according to claim 1, further including a third graphical representation including at least one trend icon that indicates one of a positive statistically significant trend relative to the goal indicated by the second indicia, a negative statistically significant trend relative to the goal indicated by the second indicia, or no statistically significant trend relative to the goal indicated by the second indicia.

5. The user interface according to claim 1, wherein the performance icon indicates a performance value selected from the group consisting of: a current monthly average value for the year of the performance metric; a current monthly average value of the performance metric; and a current weekly average value of the performance metric.

6. The user interface according to claim 2, wherein actuation of one of the plurality of icons causes the interface to display a third graphical representation including additional data related to the actuated graphical representation.

7. A computer implemented system for transforming a standard health care providing system into a learning health care system comprising:
a process for engagement between a requester and a research and discovery unit,
a process for providing research and discovery unit services before, during, and after implementation of the system, and
a user interface displayed on a computer providing metrics on improved costs to patients and health care providers, improved health of patients, and improved care offered by the health care providers and received by patients.

8. The system according to claim 7, wherein the user interface is the user interface according to claim 1.

9. The system according to claim 7, wherein the process for engagement comprises at least one of one of a letter of inquiry, a diagnosis, and an initial consultation between the requester and the research and discovery unit.

10. The system according to claim 7, wherein the research and discovery unit services comprise identification of opportunities for improvement within a health care system, critical review of an area where an opportunity for improvement exists, identification of a problem, identification of a current deficiency in the health care system, identification of personnel and methods needed to eliminate the deficiency in the health care system, identification of a desired state of the system, identification of evidence-based solutions to solve the problem, development of an implementation plan, creation of a communication plan, localization of an identified evidence-based solution, and creation of an evaluation plan.

11. The system according to claim 10, wherein the area is selected from the group consisting of: a service line, a hospital, a health plan, a doctor's office, a medical facility, an outpatient center, and a medical school.

12. The system according to claim 10, wherein the research and discovery unit services further comprise a knowledge bank and a feedback loop.

13. A method for transforming a standard health care providing system into a learning health care system comprising:
providing a process for engagement between a requester and a research and discovery unit,
providing research and discovery unit services before, during, and after implementation of the system, and
utilizing a user interface displayed on a computer providing metrics on improved costs to patients and health care providers, improved health of patients, and improved care offered by the health care providers and received by patients.

14. The method according to claim 13, wherein the user interface is the user interface according to claim 1.

15. The method according to claim 13, wherein the process for engagement comprises at least one of a letter of inquiry, a diagnosis, and an initial consultation between the requester and the research and discovery unit.

16. The method according to claim 13, wherein the research and discovery unit services comprise identification of opportunities for improvement within a health care system, critical review of an area where an opportunity for improvement exists, identification of a problem, identification of a current deficiency in the health care system, identification of personnel and methods needed to eliminate the deficiency in the health care system, identification of a desired state of the system, identification of evidence-based solutions to solve the problem, development of an implementation plan, creation of a communication plan, localization of an identified evidence-based solution, and creation of an evaluation plan.

17. The method according to claim 16, wherein the area is selected from the group consisting of: a service line, a hospital, a health plan, a doctor's office, a medical facility, an outpatient center, and a medical school.

18. The method according to claim 13, wherein the research and discovery unit services further comprise a knowledge bank and a feedback loop.
